(19) United States
(12) Patent Application Publication
(10) Pub. No.: US 2026/0064787 A1
(43) Pub. Date: Mar. 5, 2026

(54) Audience-Based Content Modification

(71) Applicant: Google LLC, Mountain View, CA (US)

(72) Inventors: Vishu Goyal, Mountain View, CA (US); Rosemond Gerold Dorleans, San Francisco, CA (US)

(21) Appl. No.: 18/825,525

(22) Filed: Sep. 5, 2024

(51) Int. Cl. G06F 16/9535; G06F 16/9538

(52) U.S. Cl. CPC G06F 16/9535; G06F 16/9538

(57) ABSTRACT

Systems and methods for audience-based content modification can include obtaining a content item from a link notes interface, obtaining a user embedding associated with a particular user, determining to augment the content item based on the user embedding, processing the content item and the user embedding with a generative language model to generate an alternative content item, and rendering the alternative content item in place of the content item within the link notes interface. The systems and methods can leverage linguistic characteristic determinations and generative model predictions to generate model-generated content items that vary based on the viewing user.

### FIELD

The present disclosure relates generally to audience-based content modification. More particularly, the present disclosure relates to augmenting link note content items by leveraging generative models and machine-learned profile representations.

### BACKGROUND

Understanding search results from a search results page can be difficult as titles and text snippets may provide limited information that may not be associated with the user's interest, which can lead to a time consuming web resource review that may not yield the desired information. Obtaining additional information on web resources can be difficult, which may include an additional search that may or may not identify relevant information.

Additionally, obtaining user insights can be difficult. In particular, users may struggle to determine which words to use. Additionally, the words may not be directed to a point-of-interest for other users and/or may not be abundant enough to generate desired results.

### SUMMARY

Aspects and advantages of embodiments of the present disclosure will be set forth in part in the following description, or can be learned from the description, or can be learned through practice of the embodiments.

One example aspect of the present disclosure is directed to a computing system for content augmentation. The system can include one or more processors and one or more non-transitory computer-readable media that collectively store instructions that, when executed by the one or more processors, cause the computing system to perform operations. The operations can include obtaining a content item to be displayed via a graphical user interface. The content item can include one or more text strings. The operations can include obtaining user profile data associated with a particular user requesting to view the graphical user interface that includes the content item. The user profile data can be descriptive of characteristics of the particular user. In some implementations, the user profile data can include a user-specific embedding representation comprising a plurality of machine-learned values. The operations can include determining to generate an alternative version of the content item based on the user-specific embedding representation of the user profile data and the one or more text strings of the content item. The operations can include processing the content item and the user-specific embedding representation of the user profile data with a generative language model to generate an alternative content item in response to determining to generate the alternative version of the content item. The alternative content item can include an augmented version of the content item based on the characteristics of the particular user. The operations can include providing the graphical user interface for display to the particular user with the content item replaced with the alternative content item.

In some implementations, the operations can include processing the user profile data to determine linguistic characteristics of the particular user based on user-generated content composed by the particular user and generating an augmentation prompt based on the linguistic characteristics. The augmentation prompt can condition the generative language model to rewrite the content item to have the linguistic characteristics of the particular user. Processing the content item and the user profile data with the generative language model to generate the alternative content item can include processing the content item and the augmentation prompt with the generative language model.

In some implementations, the operations can include determining one or more topics of the content item, processing the user profile data to determine topic expertise of the particular user based on user-generated content composed by the particular user, and generating an augmentation prompt based on the topic expertise. The augmentation prompt can condition the generative language model to rewrite the content item based on the topic expertise of the particular user. Processing the content item and the user profile data with the generative language model to generate the alternative content item can include processing the content item and the augmentation prompt with the generative language model. The topic expertise can be associated with the one or more topics of the content item. In some implementations, the augmentation prompt may condition the generative language model to augment the content item to include additional topic details in response to the topic expertise being descriptive of a novice level of topic expertise. The augmentation prompt may condition the generative language model to augment the content item to include domain-specific terminology in response to the topic expertise being descriptive of an expert level of topic expertise.

In some implementations, the content item can include a link note. The link note can be descriptive of a comment left by one or more other users linked to a web resource. The link note can be provided for display when the web resource is provided as a search result. In some implementations, the graphical user interface can include a search result interface. The operations may include obtaining a search query from a user computing device associated with the particular user, determining a plurality of search results responsive to the search query, and determining to provide the content item for display based on the content item being indexed with information associated with at least one of the plurality of search results. The content item and the user profile data can be obtained in response to determining to provide the content item for display.

Another example aspect of the present disclosure is directed to a computer-implemented method for content augmentation. The method can include obtaining, by a computing system including one or more processors, a content item to be displayed via a graphical user interface. The content item can include one or more text strings. The method can include obtaining, by the computing system, historical user data associated with a particular user requesting to view the graphical user interface that includes the content item. The historical user data can be descriptive of linguistic characteristics of previous content items the particular user has interacted with in previous content interactions. The method can include determining, by the computing system, an augmentation action based on the linguistic characteristics and the one or more text strings of the content item. In some implementations, the augmentation action can include augmenting the content item to include at least a subset of the linguistic characteristics of the historical user data. The method can include processing, by the computing system, the content item and the augmentation action with a generative language model to generate an alternative content item. The alternative content item can include an augmented version of the content item that comprises the at least the subset of the linguistic characteristics. The method can include providing, by the computing system, the graphical user interface for display to the particular user with the content item replaced with the alternative content item.

In some implementations, the method can include determining, by the computing system, the linguistic characteristics are associated with a particular dialect. The augmentation action can include augmenting the content item to include the terminology and syntactical structure of the particular dialect. The particular dialect can be a region-specific dialect.

In some implementations, the content item can include a multimodal content item. The multimodal content item can include the one or more text strings and one or more images. The method can include processing, by the computing system, the historical user data to determine image preferences of the particular user based on previous content items the particular user has interacted with in previous content interactions; processing, by the computing system, the one or more images and the image preferences with an image augmentation model to generate one or more augmented images based on the image preferences; and providing, by the computing system, the graphical user interface for display to the particular user with the one or more images replaced with the one or more augmented images. In some implementations, the one or more augmented images can be generated by augmenting the one or more images to adjust at least one of the brightness, contrast, smoothness, or colors of the one or more images.

Another example aspect of the present disclosure is directed to one or more non-transitory computer-readable media that collectively store instructions that, when executed by one or more computing devices, cause the one or more computing devices to perform operations. The operations can include obtaining a content item for inclusion in a graphical user interface. The content item can include one or more text strings. The operations can include obtaining user profile data associated with a particular user requesting to view the graphical user interface that comprises the content item. The user profile data can be descriptive of previous content items viewed by the particular user. The operations can include determining one or more topics associated with the one or more text strings of the content item and processing the one or more topics and the user profile data to determine one or more expertise levels of the particular user. The one or more expertise levels of the particular user can be descriptive of a determined level of knowledge of the particular user with the one or more topics. The operations can include processing the content item and data descriptive of the one or more expertise levels of the particular user with a generative language model to generate an alternative content item. The alternative content item can include an augmented version of the content item based on the one or more expertise levels of the particular user. The operations can include providing the graphical user interface for display to the particular user with the content item replaced with the alternative content item.

In some implementations, the operations can include determining to generate an alternative version of the content item based on the one or more expertise levels and the one or more text strings of the content item. The content item can include a graphical card generated based on a plurality of user inputs by one or more other users. Determining to generate the alternative version of the content item can include determining a difference in knowledge expertise of the particular user and the one or more users with respect to the one or more topics. In some implementations, the alternative content item can be generated on a user computing device associated with the particular user.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example content modification system according to example embodiments of the present disclosure.

FIG. 2 depicts a block diagram of an example alternative content item generation system according to example embodiments of the present disclosure.

FIG. 3 depicts a flow chart diagram of an example method to perform alternative content item generation according to example embodiments of the present disclosure.

FIGS. 4A-4B depict illustrations of example content alternatives according to example embodiments of the present disclosure.

FIG. 5 depicts a block diagram of an example prompt template generation system according to example embodiments of the present disclosure.

FIG. 6 depicts a block diagram of an example prompt generation system according to example embodiments of the present disclosure.

FIG. 7 depicts a flow chart diagram of an example method to perform augmentation determination and performance according to example embodiments of the present disclosure.

FIG. 8 depicts a flow chart diagram of an example method to perform topic-based modification according to example embodiments of the present disclosure.

FIGS. 9A-9G depict illustrations of example graphical card interfaces according to example embodiments of the present disclosure.

FIG. 10A depicts a block diagram of an example computing system that performs audience-based content modification according to example embodiments of the present disclosure.

FIG. 10B depicts a block diagram of an example computing system that performs audience-based content modification according to example embodiments of the present disclosure.

FIG. 11 depicts an illustration of an example content item generation interface according to example embodiments of the present disclosure.

FIG. 12 depicts an illustration of an example image suggestion interface according to example embodiments of the present disclosure.

FIG. 13 is a flow chart diagram illustrating an example method for training a machine-learned model according to example implementations of aspects of the present disclosure.

FIG. 14 is a block diagram of an example processing flow for using machine-learned model(s) to process input(s) to generate output(s) according to example implementations of aspects of the present disclosure.

FIG. 15 is a block diagram of an example sequence processing model according to example implementations of aspects of the present disclosure.

FIG. 16 is a block diagram of an example technique for populating an example input sequence for processing by a sequence processing model according to example implementations of aspects of the present disclosure.

FIG. 17 is a block diagram of an example model development platform according to example implementations of aspects of the present disclosure.

FIG. 18 is a block diagram of an example training workflow for training a machine-learned model according to example implementations of aspects of the present disclosure.

FIG. 19 is a block diagram of an inference system for operating one or more machine-learned model(s) to perform inference according to example implementations of aspects of the present disclosure.

FIG. 20 is a block diagram of an example networked computing system according to example implementations of aspects of the present disclosure.

FIG. 21 is a block diagram of an example computing device according to example implementations of aspects of the present disclosure.

FIG. 22 is a block diagram of an example computing device according to example implementations of aspects of the present disclosure.

Reference numerals that are repeated across plural figures are intended to identify the same features in various implementations.

### DETAILED DESCRIPTION

Generally, the present disclosure is directed to systems and methods for generating alternative versions of a link note content item (and/or other content items) based on the particular user viewing the content at a given search instance. In particular, the systems and methods disclosed herein can leverage user embeddings, a link notes interface, and/or a generative model to dynamically adjust the link notes interface to provide the semantic information of a link note while adjusting the content item based on the knowledge and/or linguistic characteristics of the user. For example, a user may provide a search query to a search interface, which can cause the system to perform a search and determine a plurality of search results. One or more search results may have one or more link notes generated based on inputs provided by one or more other users. The one or more link notes can be descriptive on the quality of the web resource search result and/or other details associated with the web resource. The systems and methods can obtain the link note content item and user profile data associated with the user (e.g., a user viewing the content item). The link note content item and the user profile data can then be processed to determine an alternative version is to be generated (e.g., the systems and methods may determine the terminology, dialect, syntax, and/or knowledge level are incompatible with the user). In some implementations, a prompt may be generated by the system in which the prompt includes a request to augment the link note content item based on user linguistic characteristics and/or a user's knowledge level of a particular topic. A generative model (e.g., a large language model) can then process the link note content item, the user profile data, and/or the prompt to generate an alternative content item (e.g., an alternative version of the content item that includes linguistic features generated based on the user profile data). The alternative content item can then be rendered within the search results interface in place of the original link note content item.

Link notes can provide insight on a web resource and/or may provide additional details on a topic of the web resource. The link notes can include user-generated content items and may be aggregated in a link notes interface and/or a collections interface to provide other users with reviews on web resources and/or other knowledge provided by other users. The link notes can be indexed with and/or associated with particular web resources. Link notes can include content (e.g., text, images, video, etc.) added by a user to characterize and/or describe the search result link.

The alternative content item can include a plurality of predicted features that are determined and/or generated based on one or more user embeddings descriptive of linguistic features, interest features, and/or knowledge features associated with a given user. The user embeddings can be descriptive of a plurality of weights, parameters and/or vectors that can be processed with a generative model (e.g., an autoregressive language model and/or a diffusion model) to condition model predictions.

Audience-based content modification may be utilized for link notes, social media posts, web pages, tutorials, and/or other content items. Different regions, different age groups, and/or different occupational experts may be provided different versions of the content item. In particular, different users may be provided content items with different terms, different structure, different tone, different levels of detail, and/or different lengths based on learned characteristics of the user. The dynamic content modification may be leveraged for dynamically altering a user interface to render different versions of the content item based on the user and/or the context.

Different users can have different levels of expertise and may have different vocabularies based on level of education, region, and/or occupation. Therefore, content items may not be readily understandable by all users. For example, a novice in the field of physics may not understand a discussion of time dilation with regards to special relativity without first being provided a primer, while an experienced physicist may need a much more concise content item to understand the same comment. Additionally, different users may prefer different sentence structures, may have different reading levels, and/or may have different lexicons.

Content can be modified/augmented to vary based on the audience and/or context of the content being viewed. The modification can be performed within a set of parameters and may be based on a known level of expertise, known successful themes, and/or learned interests. For example, the terminology and/or level of detail may be changed by leveraging a generative model (e.g., a large language model) and/or search engines to reword and/or supplement a user-generated content item. The generative model may process a user embedding to condition the generation and/or may generate a prompt based on the content item and the user profile data, which can then be processed to generate the alternative content item.

The audience-based content modification can expand the potential reach for content items. Additionally and/or alternatively, the modification can include generating child safe versions of content items. Dense content items may be expanded for viewers who are new to the topic. Terminology of the content items can be changed for age appropriateness, reading level, region, and/or personal lexicons.

The systems and methods disclosed herein can be utilized for a plurality of different content item instances. For example, the content modification can be utilized to modify link note content items, articles, blogs, social media posts, subtitles of videos, animated images, memes, emails, stories, definitions, and/or other content items. The content modification can be performed for users viewing content and/or may be performed for users composing a content item. For example, a user composing a content item can have their current version of the text, images and/or other content processed to generate one or more alternative versions that a user may post, edit, and/or add to a database for use as an alternative version of the content item.

The systems and methods of the present disclosure provide a number of technical effects and benefits. As one example, the system and methods can provide a dynamic content interface that adjusts the content provided for display based on the user viewing the interface. In particular, the systems and methods disclosed herein can leverage one or more machine-learned models to determine when to generate alternative versions of content items and then generate the alternative version to then be rendered in place of the original content item. For example, a generative model can process user data, content data, and/or other context data to determine an augmentation/content generation to be performed. Additionally and/or alternatively, the generative model may generate an alternative version of content item based on a user-specific embedding to generate an alternative content item that includes the details of the original content item composed into an alternative content item tailored to the linguistic characteristics and/or knowledge level of the user.

Another technical benefit of the systems and methods of the present disclosure is the ability to leverage user data and content data to determine which users to provide which alternative version. For example, a user can be determined to be knowledgeable on a particular topic and/or be a common note poster for a given type of content. Based on the determination, the user may be provided with a particular alternative version of the content item that is associated with that knowledge level. Alternatively and/or additionally, the topic of the content, the type of content, and/or other interactions with the content can be utilized to determine the link note is a candidate for alternative version generation to provide an alternative version tailored for different potential viewer groups.

The systems and methods disclosed herein addresses a problem generated by computing systems obtaining, processing, and transmitting data from a plurality of databases from a plurality of sources. The immense volume of data available to users can provide potential for misinformation, misdirection, and/or lack of verification. Text snippets, titles, and/or example images in a search results interface may provide some details on contents of a web resource; however, information from other users can provide further insight on topic, trustworthiness, and/or what to expect, which can be leveraged to reduce instances of irrelevant web resources being navigated and reviewed by the user.

Another example of technical effect and benefit relates to improved computational efficiency and improvements in the functioning of a computing system. For example, the systems and methods disclosed herein can store the model-generated alternative content items to then be utilized upon determining a user with similar characteristics is requesting to view the content item. Therefore, the alternative content item generation may be limited to new linguistic characteristic determinations, which can reduce the computational cost and latency of the system as a single model inference may be utilized for a plurality of different users without having to perform a new model inference for each new user.

With reference now to the Figures, example embodiments of the present disclosure will be discussed in further detail.

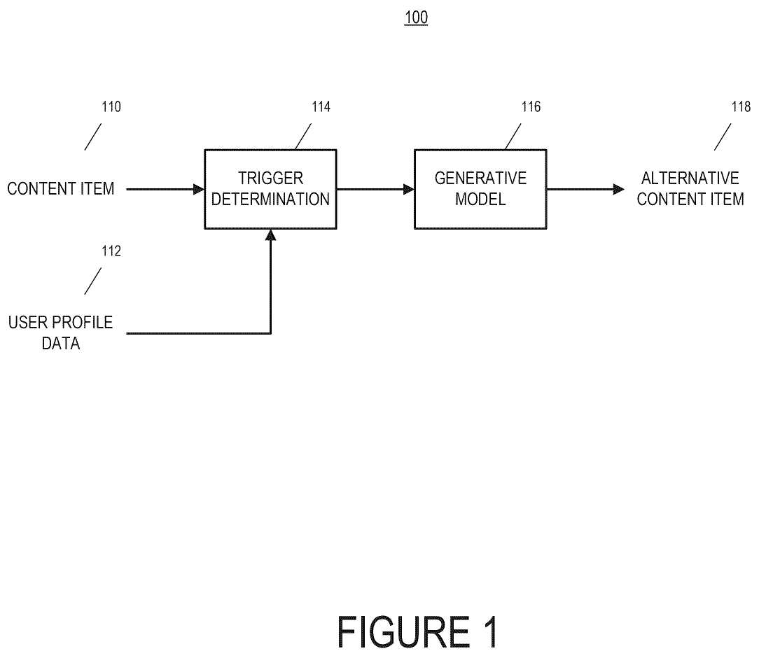

FIG. 1 depicts a block diagram of an example content modification system 100 according to example embodiments of the present disclosure. In some implementations, the content modification system 100 is configured to receive, and/or obtain, a request for content item 110 descriptive of a user-generated link note associated with a web resource and, as a result of receipt of the request for the content item 110, generate, determine, and/or provide an alternative content item 118 that is descriptive of the details of the content item 110 augmented based on a user embedding associated with user profile data 112. Thus, in some implementations, the content modification system 100 can include a generative model 116 that is operable to perform a plurality of sequential predictions to generate the alternative content item 118 based on the user embedding and a generated embedding of the content item 110.

In particular, the content modification system 100 can obtain a content item 110. The content item 110 can be a link note content item associated with a particular web resource in which the link note content item includes details discussing the particular web resource and/or aspects of the particular web resource content. In some implementations, the content item 110 can include an article, a social media post, a graphical card that includes text and image, a blog, a poster, etc. The content item 110 may be obtained from one or more databases via an application programming interface of a user interface.

In response to receiving a request to display the content item 110, the content modification system 100 can obtain user profile data 112 from a profile database and/or local storage. The user profile data 112 can include a user-specific embedding representation descriptive of features associated with user interests, user interactions, user-generated content, user preferences, and/or other user data. The user-specific embedding representation can include a plurality of machine-learned weights that may have been tuned based on user-generated content, a user search history, a user browsing history, and/or other user data. In some implementations, the user-specific embedding representation may include a set of values generated with an embedding model comprising one or more encoders. The user-specific embedding representation can include a set of values that may condition generative model predictions. The user-specific embedding representation can include a plurality of model-readable values that may not be readily-readable by a human.

A trigger determination block 114 can process the content item 110 and at least a subset of the user profile data 112 (e.g., the user-specific embedding representation) to determine whether alternative content item 118 is to be generated. The trigger determination block 114 may determine to generate the alternative content item 118 based on the content item 110 having linguistic features (e.g., terms, syntax, reading level, dialect, etc.) that are contrary to features of user-generated content and/or content historically viewed by the user. Alternatively and/or additionally, the trigger determination block 114 may determine to generate the alternative content item 118 based on the content item 110 having a level of expertise in a particular topic that differs from the level of knowledge of the user in that specific topic. In some implementations, the trigger determination block 114 may include one or more classification models, one or more natural language processing models, one or more detection models, and/or one or more other machine-learned models. The trigger determination block 114 may be part of and/or include a prompt generation model that generates a prompt based on the content item 110 and the user profile data 112.

A generative model 116 can process the content item 110, the user profile data 112 (e.g., the user-specific embedding representation), and/or a prompt to generate the alternative content item 118. The generative model 116 can include one or more transformer models. The generative model 116 may include an autoregressive language model and/or a diffusion model. The generative model 116 may include a text generation model (e.g., a large language model), an image generation model (e.g., a text-to-image model), an audio generation model, a video generation model, and/or other data generation models. The alternative content item 118 can include text data, image data, audio data, video data, latent encoding data, multimodal data, and/or other data. The alternative content item 118 may include novel synthetic data that differs from training data and/or other data provided to the generative model 116. The alternative content item 118 may include a predicted rewriting of the content item 110 based on the user profile data 112 in order to provide a more digestible and understandable version to the user.

The alternative content item 118 can then be rendered in the user interface in place of the content item 110. In some implementations, the alternative content item 118 may be stored and/or cached for future viewing instances and/or for providing to other users with similar characteristics to the user.

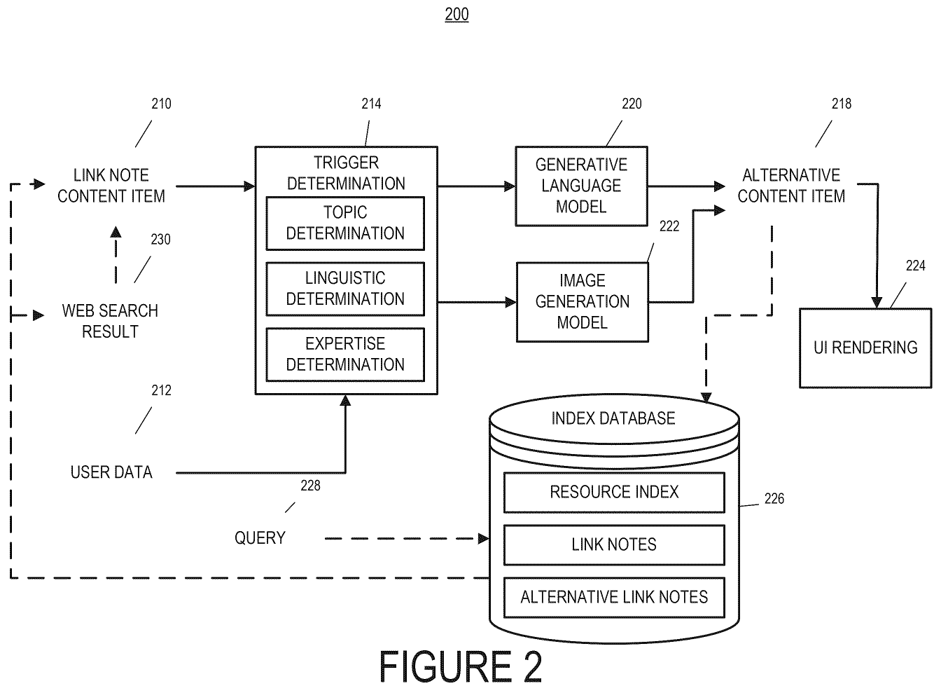

FIG. 2 depicts a block diagram of an example alternative content item generation system 200 according to example embodiments of the present disclosure. The alternative content item generation system 200 is similar to content modification system 100 of FIG. 1 except that alternative content item generation system 200 further includes index database 226 access and updating.

In particular, the alternative content item generation system 200 can obtain a search query 228 via a search interface. The search interface can include a search engine that may perform searches based on key words, embedding generation and search, feature matching, classification label-based search, and/or other search techniques. The query 228 may include one or more text strings, one or more images, one or more embeddings, one or more audio clips, multimodal data, and/or other data.

The search engine may process the query 228 to determine one or more web resources are responsive to the query 228 based on searching an index database 226. The one or more web resources can include a web search result 230.

The alternative content item generation system 200 can obtain a link note content item 210 associated with the web search result 230 from the index database 226. The link note content item 210 can be associated with a particular web resource of the web search result 230 in which the link note content item includes details discussing the particular web resource and/or aspects of the particular web resource content. In some implementations, the link note content item 210 can include an article, a social media post, a graphical card that includes text and image, a blog, a poster, etc. The link note content item 210 may be obtained from one or more databases via an application programming interface of a user interface. For example, an application programming interface call can be generated and utilized.

In response to receiving a request to display the link note content item 210, the alternative content item generation system 200 can obtain user profile data 212 from a profile database and/or local storage. The user profile data 212 can include a user-specific embedding representation descriptive of features associated with user interests, user interactions, user-generated content, user preferences, and/or other user data. The user-specific embedding representation can include a plurality of machine-learned weights that may have been tuned based on user-generated content, a user search history, a user browsing history, and/or other user data. In some implementations, the user-specific embedding representation may include a set of values generated with an embedding model comprising one or more encoders. The user-specific embedding representation can include a set of values that may condition generative model predictions. The user-specific embedding representation can include a plurality of model-readable values that may not be readily-readable by a human.

A trigger determination block 214 can process the link note content item 210 and at least a subset of the user profile data 212 (e.g., the user-specific embedding representation) to determine whether alternative content item 218 is to be generated. The trigger determination block 214 can perform a topic determination, a linguistic determination, and/or an expertise determination for the content item in order to perform the trigger determination. For example, the trigger determination block 214 may process the content item with a language model, a semantic understanding model, and/or a topic classification to determine one or more topics associated with the link note content item 210. The expertise level of the link note content item 210 can be determined based on a language model, search engine processing, and/or classification model. The user profile data 212 may then be processed to determine the user's expertise level for the particular topic of the link note content item 210. The content item expertise level and the user expertise level can then be compared to determine, whether the relative level of expertise are similar or if an alternative content item 218 is to be generated to provide an alternative version that better matches the expertise level of the user. For example, the alternative content item 218 may be generated to include a primer on the topic and/or provide more succinct terminology.

Alternatively and/or additionally, linguistic characteristics of the link note content item 210 and the user can be determined and compared. If the linguistic characteristics are compatible, the original link note content item 210 may be provided for display. If the linguistic characteristics are incompatible, the alternative link note content item 218 may be generated.

The trigger determination block 214 may determine to generate the alternative content item 218 based on the link note content item 210 having linguistic features (e.g., terms, syntax, reading level, dialect, etc.) that are contrary to features of user-generated content and/or content historically viewed by the user. Alternatively and/or additionally, the trigger determination block 214 may determine to generate the alternative content item 218 based on the link note content item 210 having a level of expertise in a particular topic that differs from the level of knowledge of the user in that specific topic. In some implementations, the trigger determination block 214 may include one or more classification models, one or more natural language processing models, one or more detection models, and/or one or more other machine-learned models. The trigger determination block 214 may be part of and/or include a prompt generation model that generates a prompt based on the link note content item 210 and the user profile data 212.

One or more generative models can then process the link note content item 210, the user profile data 212 (e.g., the user-specific embedding representation), and/or a prompt to generate the alternative content item 218. The link note content item 210 may include multimodal data, and the generation of the alternative content item 218 may include leveraging a generative language model 220 (e.g., an autoregressive language model) for the text generation and an image generation model 222 (e.g., a diffusion model) for the image generation. The model-generated text and the model-generated image(s) can then be processed to generate the alternative content item 218. The alternative content item 218 may include a graphical card. The generative models can include one or more transformer models. The generative models may include a text generation model (e.g., a large language model), an image generation model (e.g., a text-to-image model), an audio generation model, a video generation model, and/or other data generation models. The alternative content item 218 can include text data, image data, audio data, video data, latent encoding data, multimodal data, and/or other data. The alternative content item 218 may include novel synthetic data that differs from training data and/or other data provided to the generative models. The alternative content item 218 may include a predicted rewriting of the link note content item 210 based on the user profile data 212 in order to provide a more digestible and understandable version to the user.

The alternative content item 218 can then be rendered 224 in the user interface in place of the link note content item 210. In some implementations, the alternative content item 218 may be stored and/or cached for future viewing instances and/or for providing to other users with similar characteristics to the user. For example, the alternative content item 218 may be transmitted to the index database 226 and stored for future searches.

The index database 226 can include a database stored on a server computing system. The index database 226 may store a resource index, link notes associated with the resource indexes, and/or alternative link notes.

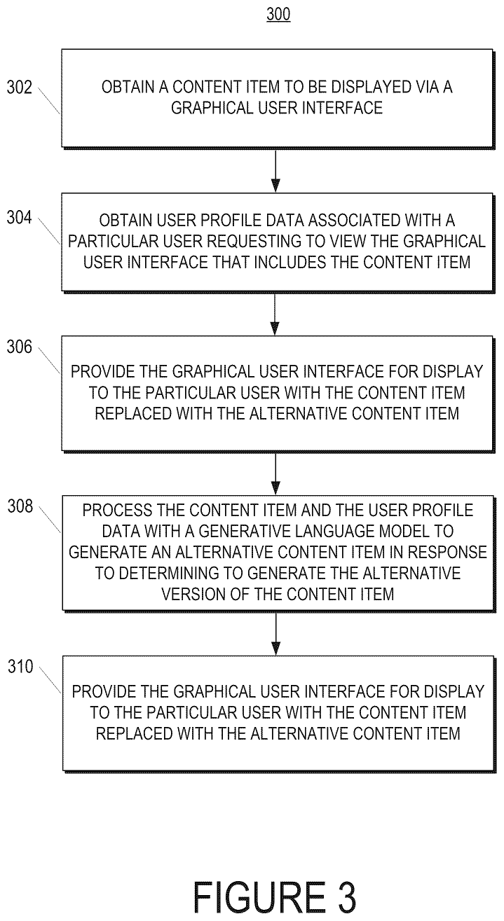

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain a content item to be displayed via a graphical user interface. The content item can include one or more text strings. In some implementations, the content item can include a link note. The link note can be descriptive of a comment left by one or more other users linked to a web resource. The link note can be provided for display when the web resource is provided as a search result. The graphical user interface can include a search result interface. The content item can include text data, image data, audio data, multimodal data, latent encoding data, and/or other types of data. The content item may be obtained via a link note interface that may be communicatively connected over a network with a link note database. The link note interface may be part of and/or work in parallel with a search interface that leverages a search engine and/or one or more search indexes. The content item may be obtained via a screen capture performed by an operating system of a user computing device. Alternatively and/or additionally, the content item may be obtained via one or more image sensors of a mobile computing device, a smart wearable (e.g., smart glasses or a smart watch), and/or other computing device.

In some implementations, the computing system can obtain a search query from a user computing device associated with the particular user, determine a plurality of search results responsive to the search query, and determine to provide the content item for display based on the content item being indexed with information associated with at least one of the plurality of search results. The content item and the user profile data can be obtained in response to determining to provide the content item for display. The plurality of search results may be determined based on embedding the search query with an embedding model to generate a query embedding in an embedding space, determining a plurality of web resource embeddings are associated with the query embedding, and determining the plurality of search results based on the plurality of web resource embeddings. The plurality of search results may be determined with a search engine and/or one or more machine-learned models.

At 304, the computing system can obtain user profile data associated with a particular user requesting to view the graphical user interface that includes the content item. The user profile data can be descriptive of characteristics of the particular user. The user profile data can include a user-specific embedding representation that includes a plurality of machine-learned values. The plurality of machine-learned values may be generated by a machine-learned embedding model and/or based on a user-specific task graph. The graphical user interface can be a link notes interface that provides the link notes for display with their respective associated web resources. The user profile data may be obtained from a server database.

At 306, the computing system can determine to generate an alternative version of the content item based on the user profile data and the one or more text strings of the content item. The determination may be performed by processing the user profile data and the content item with a generative language model to determine whether the one or more text strings comprise features that are associated with topics, syntax, and/or language that are determined to be relevant to the user based on the user profile data. The determination may be based on the user-specific embedding representation. The user profile data may include a task graph that comprises an embedding representation of a plurality of interests of the user, which may include nodes associated with learned interests and edges descriptive of predicted connections between interests.

At 308, the computing system can process the content item and the user profile data with a generative language model to generate an alternative content item in response to determining to generate the alternative version of the content item. The alternative content item can include an augmented version of the content item based on the characteristics of the particular user. The alternative version can include a plurality of predicted character sequences. In some implementations, the alternative content item may include a model-generated image generated with an image generation model (e.g., a diffusion model). The generation may be based on the user-specific embedding representation.

In some implementations, the computing system can process the user profile data to determine linguistic characteristics of the particular user based on user-generated content composed by the particular user and generate an augmentation prompt based on the linguistic characteristics. The augmentation prompt can condition the generative language model to rewrite the content item to have the linguistic characteristics of the particular user. In some implementations, processing the content item and the user profile data with the generative language model to generate the alternative content item can include processing the content item and the augmentation prompt with the generative language model.

Alternatively and/or additionally, the computing system can determine one or more topics of the content item, process the user profile data to determine topic expertise of the particular user based on user-generated content composed by the particular user, and generate an augmentation prompt based on the topic expertise. The augmentation prompt can condition the generative language model to rewrite the content item based on the topic expertise of the particular user. In some implementations, processing the content item and the user profile data with the generative language model to generate the alternative content item can include processing the content item and the augmentation prompt with the generative language model. The topic expertise can be associated with the one or more topics of the content item. The augmentation prompt may condition the generative language model to augment the content item to include additional topic details in response to the topic expertise being descriptive of a novice level of topic expertise. In some implementations, the augmentation prompt may condition the generative language model to augment the content item to include domain-specific terminology in response to the topic expertise being descriptive of an expert level of topic expertise.

At 310, the computing system can provide the graphical user interface for display to the particular user with the content item replaced with the alternative content item. The graphical user interface may include a link notes interface, a search results page interface, a social media interface, and/or other form of interface. The alternative content item may be rendered over the content item within the graphical user interface. The alternative content item may be provided for display via a touchscreen display of a mobile computing device and/or an augmented-reality rendering via mobile computing device and/or a smart wearable (e.g., smart glasses).

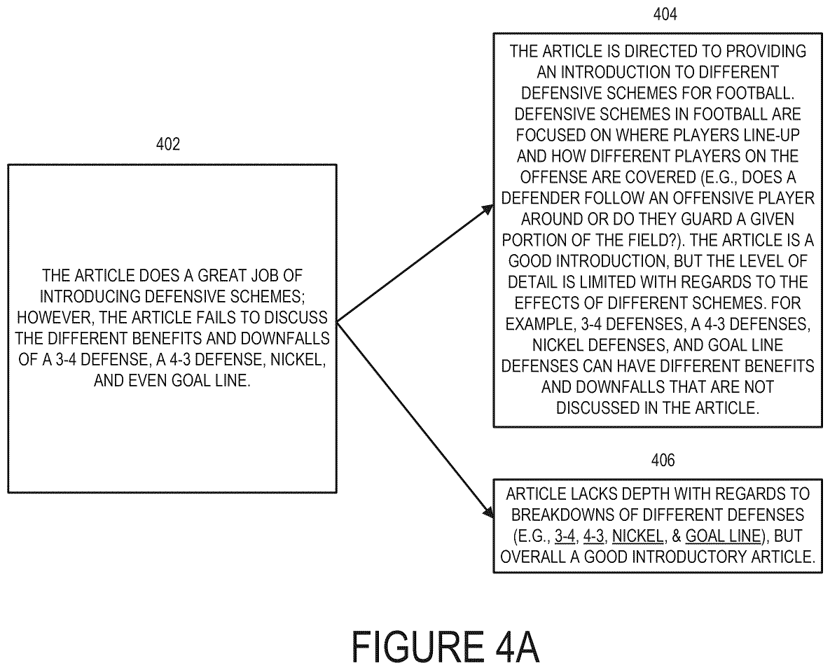

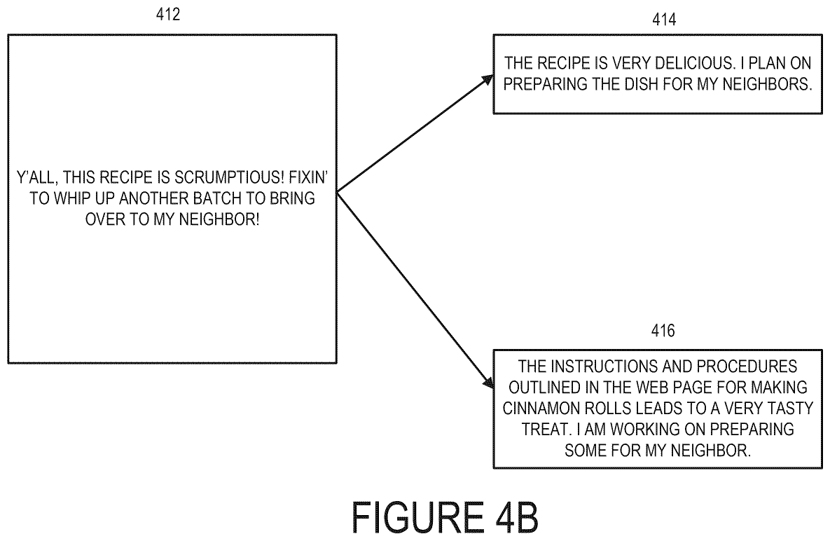

FIGS. 4A-4B depict illustrations of example content alternatives according to example embodiments of the present disclosure. In particular, FIG. 4A depicts a first example link note content item 402 (e.g., a link note associated with a football coaching article) and two alternative content items for the first example link note content item 402. For a user determined to have a low level of knowledge in the field of football, the expanded alternative content item 404 may be generated. For a user determined to have a high level of knowledge in the field of football, the condensed alternative content item 406 may be generated.

FIG. 4B depicts a second example link note content item 412 (e.g., a link note associated with a baking recipe written with southern slang) and two alternative content items for the second example link note content item 412. For a user determined to have a concise and plain writing, the plain language alternative content item 414 may be generated. For a user determined to have a preference towards more detailed content items, the detailed alternative content item 416 may be generated.

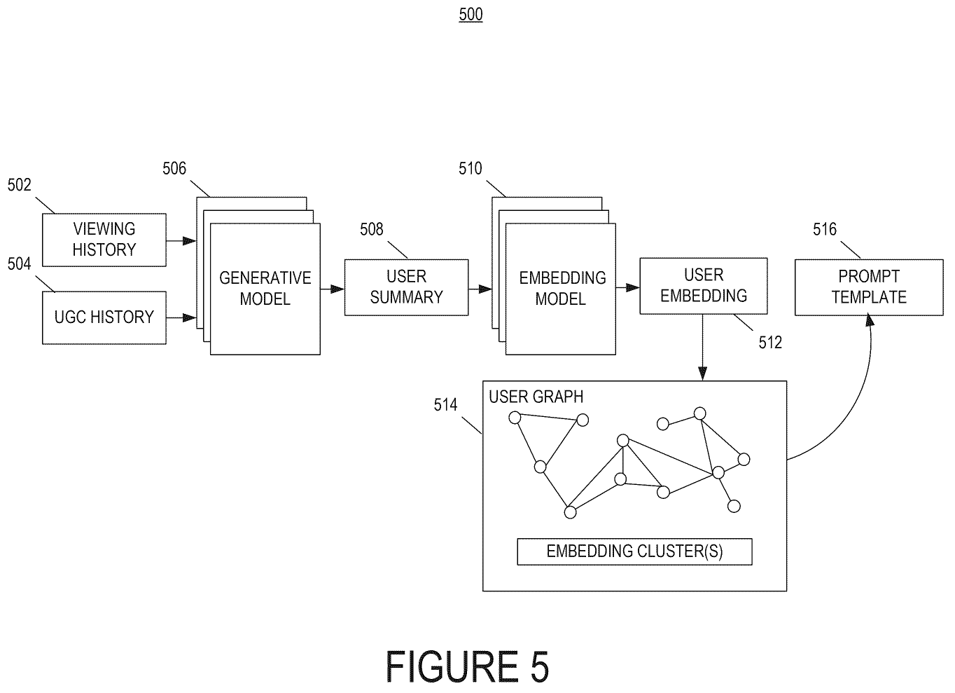

FIG. 5 depicts a block diagram of an example prompt template generation system 500 according to example embodiments of the present disclosure. In particular, the systems and methods disclosed herein may leverage the prompt template generation system 500 to generate prompt templates based on user data that can then be utilized to generate a prompt for the generative model to process.

For example, the prompt template generation system 500 can obtain a user viewing history 502, a user-generated content history 504 (e.g., a log of content created by the user), and/or other user data (e.g., a search history, a browsing history, occupation history, social media data, and/or preference data). The user viewing history 502, the user-generated content history 504, and/or other user data can be processed with a generative model 506 to generate a user summary 508. The user summary 508 can be descriptive of user interests, user styles, user preferences, user expertise, and/or other aggregated user summary information.

The user summary 508 can then be processed with an embedding model 510 to generate a user embedding 512. The user embedding 512 can then be added to a user embedding graph 514 descriptive of user tastes, styles, and preferences. The user embedding 512 may be utilized to add nodes and/or edges to the user embedding graph 514. Each node may be associated with a different learned user detail and each edge may be associated with determined connections between nodes. The prompt template generation system 500 may leverage the nodes and edges to generate prompt templates 516 and/or to determine which prompt templates 516 to utilize.

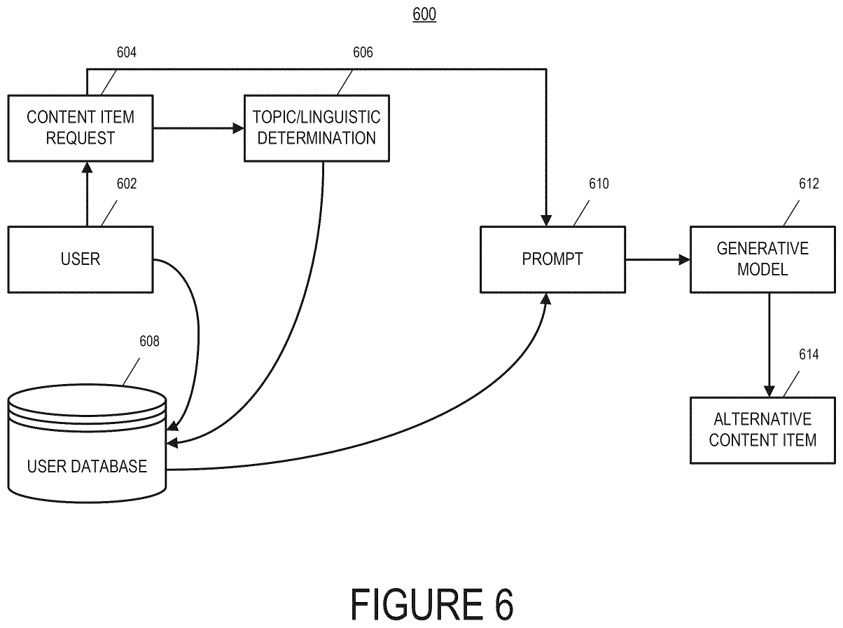

FIG. 6 depicts a block diagram of an example prompt generation system 600 according to example embodiments of the present disclosure. In particular, the prompt templates 516 of FIG. 5 may be utilized to generate a prompt 610 that can then be processed by the generative model 612 to generate the alternative content item 614.

For example, a user 602 may provide a query that may lead to a content item request 604 to be generated. The content item request 604 may be associated with requesting a link note or other content item for display. The content item can be processed to perform a topic and/or linguistic determination 606. The output of the topic and/or linguistic determination 606 can then be utilized to query a user database 608 for relevant information on the user 602. The user database 608 search can be leveraged to obtain a prompt template, which can then be processed with the content item to generate the prompt 610. The prompt 610 may include a hard prompt, a soft prompt, and/or a hybrid prompt. The prompt 610 can then be processed with the generative model 612 to generate the alternative content item 614.

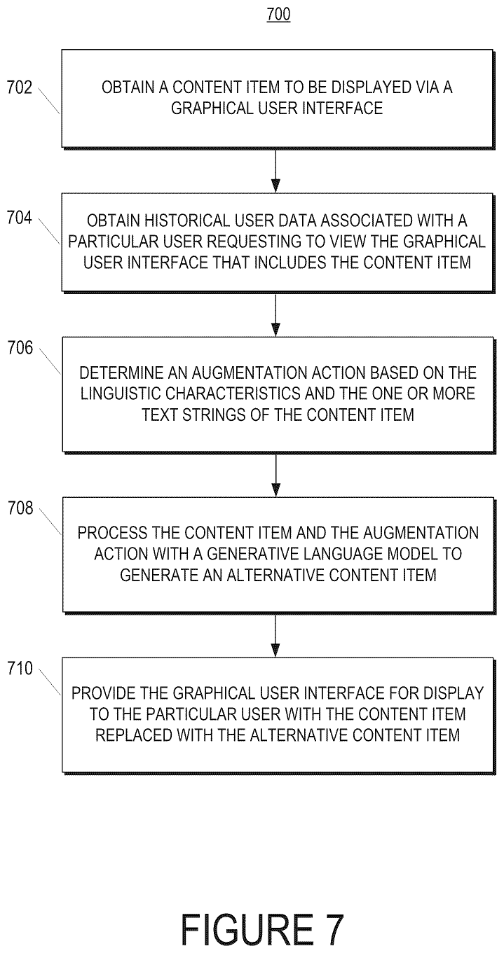

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain a content item to be displayed via a graphical user interface. The content item can include one or more text strings. The content item may further include one or more images, one or more audio clips, one or more signals, metadata, and/or other data. The content item may be obtained via one or more image sensors, one or more image capture applications, an operating system capture, a mark-up language retrieval, and/or other technique.

At 704, the computing system can obtain historical user data associated with a particular user requesting to view the graphical user interface that includes the content item. The historical user data can be descriptive of linguistic characteristics of previous content items the particular user has interacted with in previous content interactions. The historical user data may include obtaining user interaction data from a user profile database stored via a cloud computing system.

At 706, the computing system can determine an augmentation action based on the linguistic characteristics and the one or more text strings of the content item. The augmentation action can include augmenting the content item to include at least a subset of the linguistic characteristics of the historical user data. The linguistic characteristics can include features descriptive of a user terminology, a user lexicon, a user dialect, a user reading level, a user technology expertise, and/or other features.

In some implementations, the computing system can determine the linguistic characteristics are associated with a particular dialect. The augmentation action can include augmenting the content item to include the terminology and syntactical structure of the particular dialect. The particular dialect can be a region-specific dialect.

At 708, the computing system can process the content item and the augmentation action with a generative language model to generate an alternative content item. The alternative content item can include an augmented version of the content item that includes the at least the subset of the linguistic characteristics. The generative language model may include an autoregressive language model that may include one or more transformer models. The generative language model may be tuned on user-generated content items via a loss function that penalizes variances from style and terminology of the user-generated content items.

At 710, the computing system can provide the graphical user interface for display to the particular user with the content item replaced with the alternative content item. Replacing the content item with the alternative content item may include augmenting the code of the results page to include the alternative content item and caching the augmented code on the user computing device. Additionally and/or alternatively, the alternative content item may be stored and/or indexed for future search instances, which may then be provided to other users with similar linguistic characteristics.

In some implementations, the content item can include a multimodal content item. The multimodal content item can include the one or more text strings and one or more images. The computing system can process the historical user data to determine image preferences of the particular user based on previous content items the particular user has interacted with in previous content interactions, process the one or more images and the image preferences with an image augmentation model to generate one or more augmented images based on the image preferences, and provide the graphical user interface for display to the particular user with the one or more images replaced with the one or more augmented images. The one or more augmented images can be generated by augmenting the one or more images to adjust at least one of the brightness, contrast, smoothness, or colors of the one or more images.

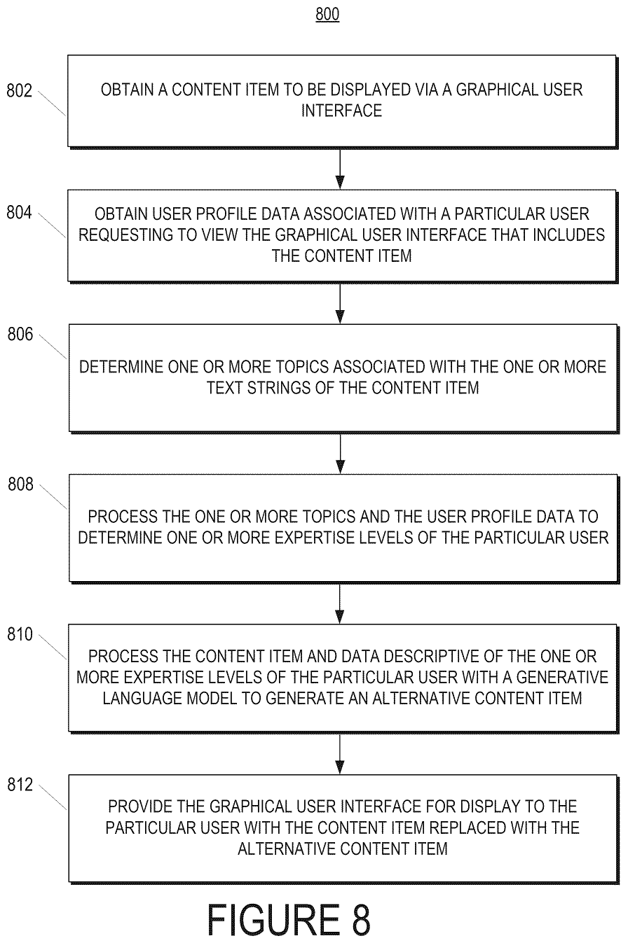

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain a content item to be displayed via a graphical user interface. The content item can include one or more text strings. The content item can include a review of a web resource, a comment on a web resource, additional details on a web resource, and/or other notes on a web resource. The content item may include a graphical card that includes text, a background, and/or user profile information descriptive of the creator of the content item.

At 804, the computing system can obtain user profile data associated with a particular user requesting to view the graphical user interface that includes the content item. The user profile data can be descriptive of previous content items viewed by the particular user. The user profile data may include a personalized model that comprises a plurality of machine-learned weights tuned based on previous user interactions.

At 806, the computing system can determine one or more topics associated with the one or more text strings of the content item. The one or more topics may be determined based on processing the one or more text strings with a classification model, a language model, a search engine, and/or other processing models. The one or more topics can include a particular technological field, a particular entertainment genre, a particular occupational field, a particular project, and/or other topic types.

At 808, the computing system can process the one or more topics and the user profile data to determine one or more expertise levels of the particular user. The one or more expertise levels of the particular user can be descriptive of a determined level of knowledge of the particular user with the one or more topics. The determined level may be determined based on a user education history, a user occupation history, a user browsing history, a user search history, previous user link notes, and/or other data.

In some implementations, the computing system can determine to generate an alternative version of the content item based on the one or more expertise levels and the one or more text strings of the content item. The content item can include a graphical card generated based on a plurality of user inputs by one or more other users. In some implementations, determining to generate the alternative version of the content item can include determining a difference in knowledge expertise of the particular user and the one or more users with respect to the one or more topics.

At 810, the computing system can process the content item and data descriptive of the one or more expertise levels of the particular user with a generative language model to generate an alternative content item. The alternative content item can include an augmented version of the content item based on the one or more expertise levels of the particular user. The alternative content item may be generated on a user computing device associated with the particular user.

At 812, the computing system can provide the graphical user interface for display to the particular user with the content item replaced with the alternative content item. The graphical user interface can include a plurality of panels and user interface elements. The graphical user interface may include a query input box, a search results panel, selectable user interface elements for viewing respective link notes interfaces for one or more of the search results, search result type tabs, selectable content augmentation tiles, and/or a knowledge panel.

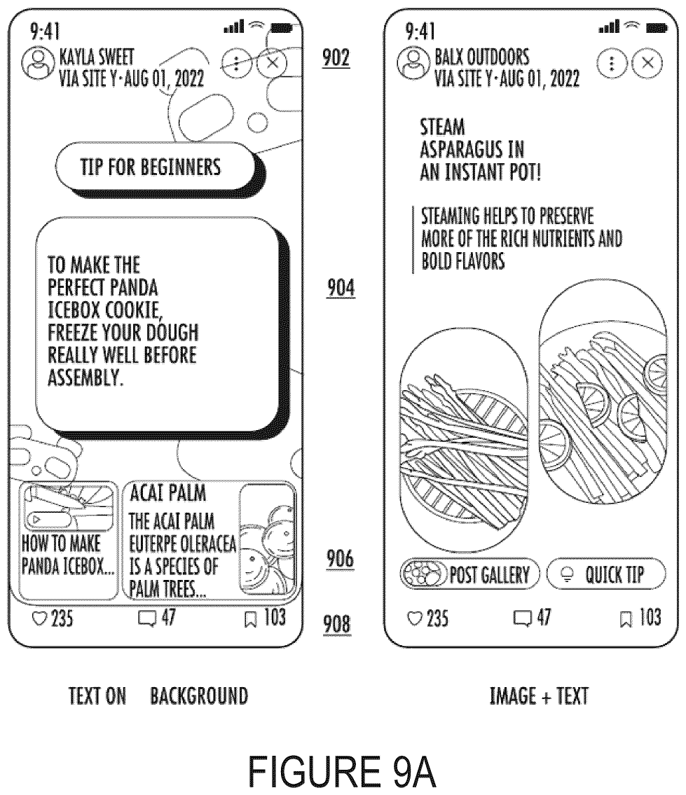

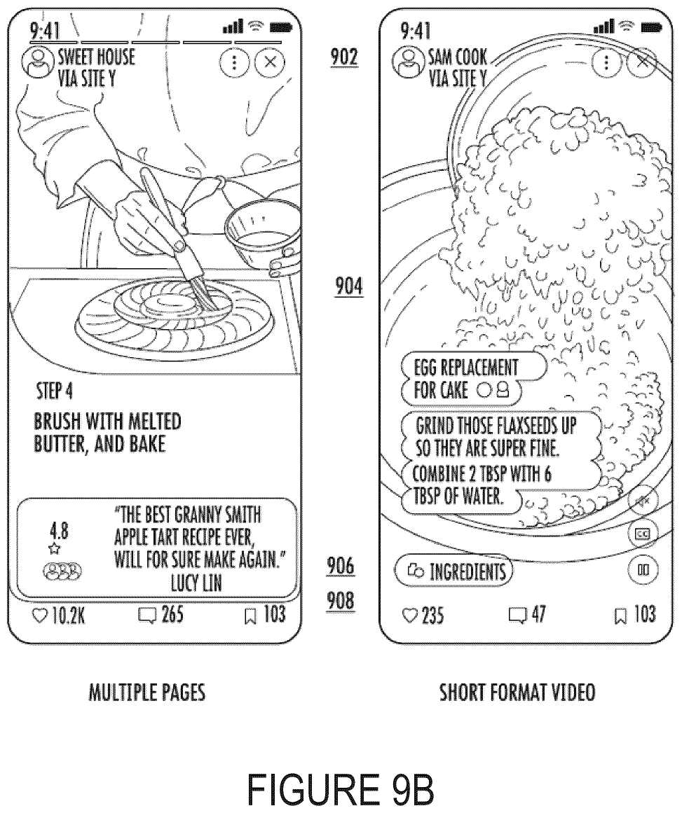

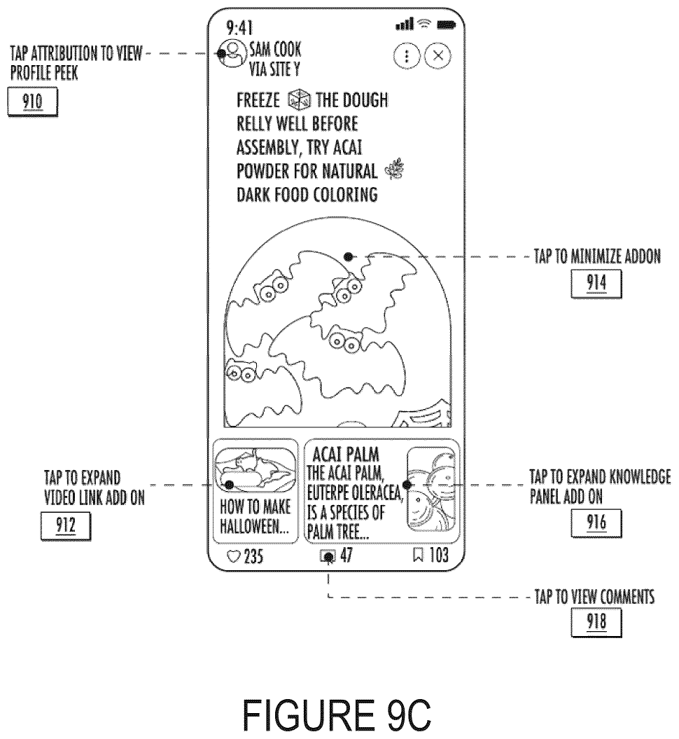

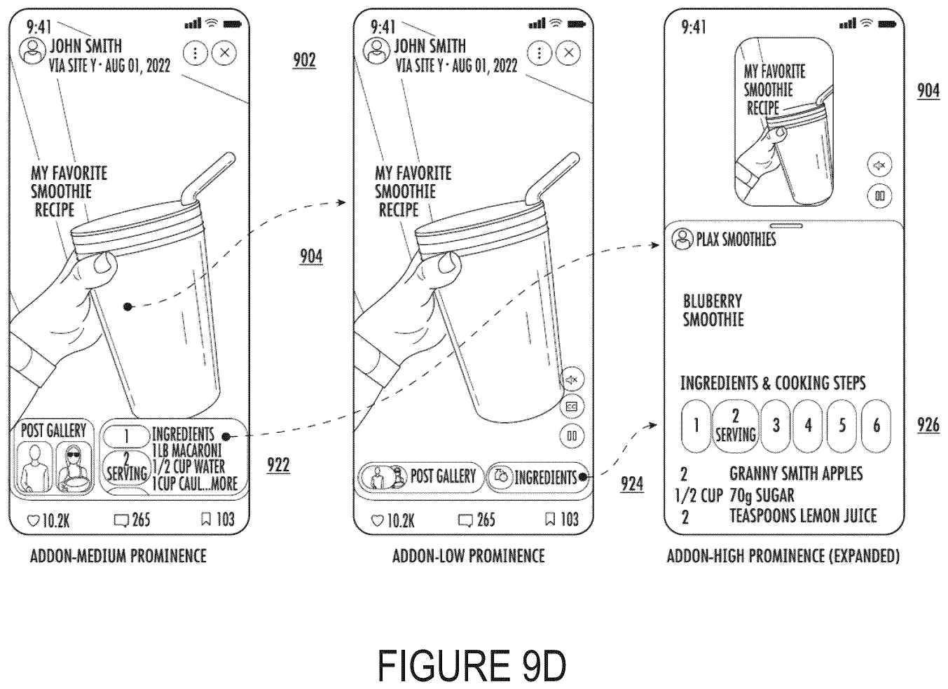

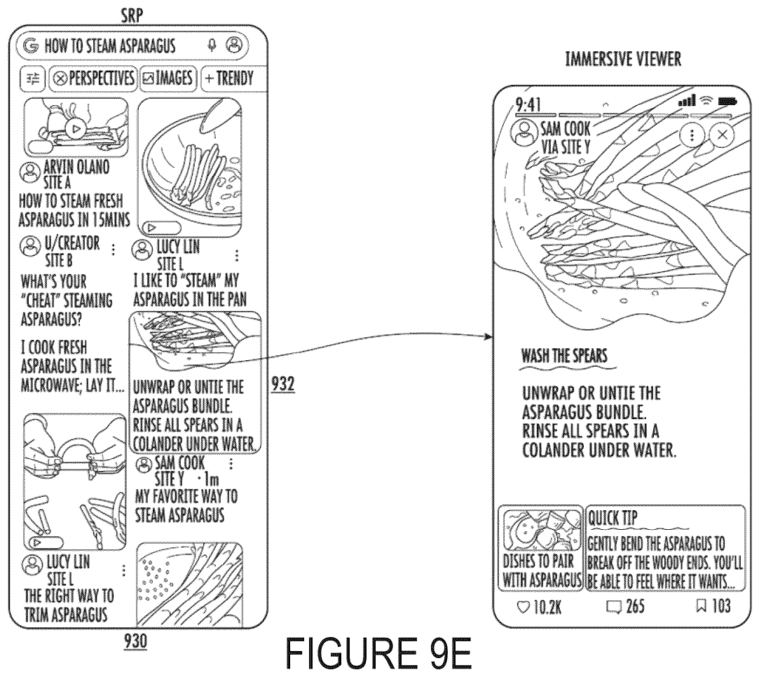

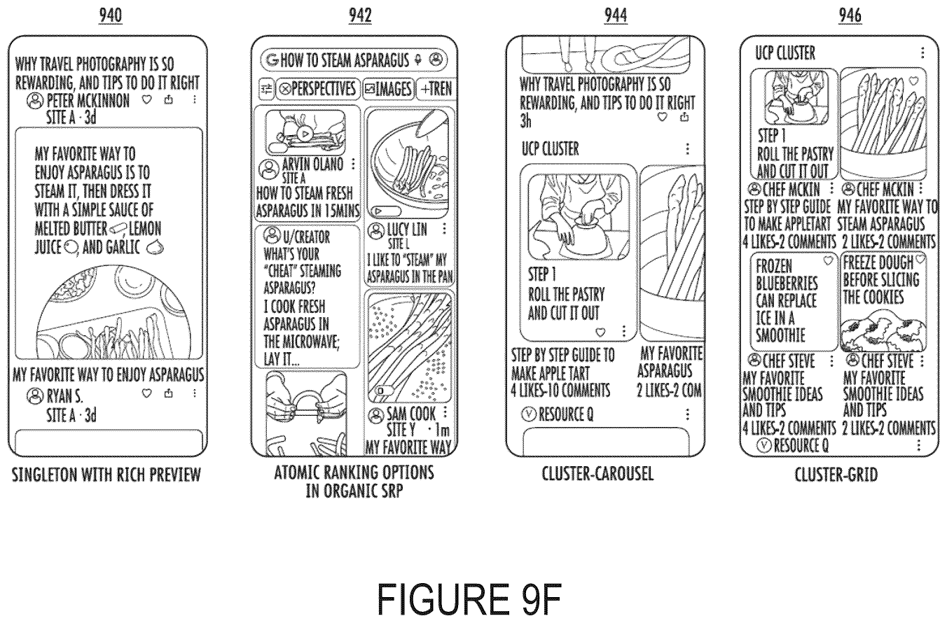

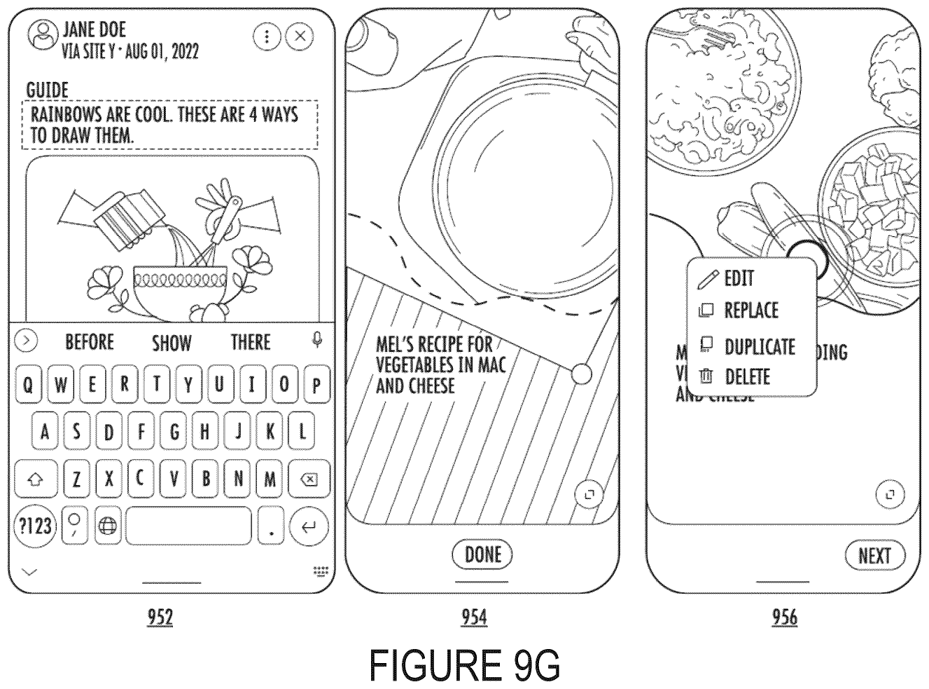

FIGS. 9A-9G depict illustrations of example graphical card interfaces according to example embodiments of the present disclosure. The systems and methods disclosed herein can be leveraged to generate graphical cards for user-generated content, which can include link notes and/or stand alone content.

FIG. 9A depicts two example graphical cards. The depicted graphical cards can include a user profile identifier 902 (e.g., a user profile image and name), the body of the card 904 (e.g., a link note in stylized text superimposed over a graphical background), widget interface elements 906 (e.g., a selectable user interface element for redirecting to a web resource and/or additional content), and/or interaction information 908 (e.g., likes, comments, and/or saves for the graphical card). The body of the card 904 can be configured by a particular user and/or may be automatically generated based on the link note, a web resource, and/or user preferences. The widget interface elements 906 can include links to web pages, links to an image gallery, links to videos, selectable elements for opening a pop-up interface, additional notes, and/or other data.

FIG. 9B depicts an example multipage user-generated content and an example video user-generated content. The multipage user-generated content can include a plurality of graphical cards that can be cycled through to display the user-generated content. The video user-generated content can include a video with graphics and/or text overlayed over the video.

Widget interface elements 906 can include a link to the web resource, a link to one or more other web resources, a video element selectable to provide a video for display, a media content display element for providing media content for display (e.g., videos, images, audio files, and/or other media), a review for the web resource, a link to other notes, a structure content item (e.g., structured recipe and/or structured calculator), a list (e.g., an ingredients list), a maps place card (e.g., a map associated with the web resource and/or a link to a web application), a knowledge panel, and/or a link to a shopping interface.

FIG. 9C depicts example interactions with a graphical card. For example, the user profile identifier 902 can be selected to peek at a user's profile 910. Additionally and/or alternatively, a video widget element 912 may be selected to expand the video for playback and/or to navigate to a video player interface. The graphical card may be selected to minimize the addon 914. A knowledge panel widget element 916 may be selected to expand a knowledge panel to provide additional information for display. The interaction elements 918 can be selected to like, comment on, save, and/or share the user-generated content.

FIG. 9D depicts prominence levels for widget interface elements (e.g., add-on elements). In particular, the ingredients and instructions for a depicted smoothie may be provided in a medium prominence interface element 922 (e.g., detail view state), a low prominence interface element 924 (e.g., a collapsed state), and/or a high prominence graphical panel 926 (e.g., an expanded state). In some implementations, a user may interact with the widget interface element to transition between the levels of detail and/or size.

FIG. 9E depicts notes search results in a search results interface 930. The notes search results can be provided in a separate tab, adjacent to other search results, and/or in a category-specific panel. A note search result 932 may be selectable to navigate to an immersive viewer 936 that displays an expanded view of the user-generated content.

FIG. 9F depicts different graphical card displays and/or note interface displays. The graphical cards may be displayed in a vertically-scrollable single width format 940, an offset vertically-scrollable two-wide format 942, a horizontally-scrollable carousel interface 944 within other search result formats, and/or an aligned vertically-scrollable two-wide format 946. The format may be based on the topic, the type of interface, user preferences, and/or a context.

FIG. 9G can depict different customization options. For example, a graphical card customization interface may be provided to generate the graphical card, which may include editing text 952, editing a layout 954, editing an image 956, and/or other customization options. In particular, the interactive interface can include a plurality of options (and/or features) for content generation. The plurality of interface features can include text, image, audio, video, template, and/or other input options. The plurality of interface features can include content suggestions, template suggestions, and/or one or more generative model interfaces for generative model aided generation (e.g., a large language model for rewriting text and/or proactively generating text; an image generation model for generating novel images based on the web resource, a user input, and/or the generated prompt; an audio generation model for generating a narration, a song, and/or other audio; and/or a graphical card generation model for processing the web resource, the generated prompt, and/or user inputs to generate a graphical card that can be suggested to the user for the link note and/or for stand alone content). The plurality of interface features can include customization options for customizing the layout, font(s), interface element size(s), image(s), text, transition(s), tone, shading, and/or other user-generated content features. The plurality of interface features can include options to add action user interface elements to a graphical card of user-generated content. The action user interface elements can include selectable options for performing one or more actions (e.g., an API call, a navigation to a different application, a search, a content item generation with a generative model, etc.).

The systems and methods disclosed herein can include image suggestion and/or image generation for generating the graphical cards. For example, the systems and methods may determine images from a database (e.g., a server database, a local database, and/or a user image gallery) is associated with the web resource, the prompt, and/or the link note. The images may then be provided as suggestions to be utilized in the graphical card. Alternatively and/or additionally, the systems and methods may provide an image generation model (e.g., a text-to-image generative model) interface to generate an image to include in the graphical card. For example, an image generation model interface can be provided to a user, the user may provide a prompt to the image generation model, and the image generation model can generate a model-generated image that can then be utilized in the graphical card.

In some implementations, one or more machine-learned models may be utilized to fact check web resources and/or the link notes. The one or more machine-learned models may include one or more generative models that can leverage application programming interfaces for API calls to obtain information and/or interact with other applications.

In some implementations, a generative model may be utilized to generate one or more model-generated link notes that can be indexed with the web resource to provide link note examples and/or provide a semantic understanding note. Alternatively and/or additionally, a generative model can be utilized to rewrite and/or suggest link notes and/or sand alone content. The interactive user interface can include an interface for interacting with a generative model to generate content (e.g., text, image(s), and/or other data). The interactive user interface can include options for selecting a tone, a style, a format, a lexicon, a genre, and/or other attributes for conditioning the generative model to generate content with a particular attribute. For example, the interactive user interface can be configured to generate a prompt for the generative model based on user inputs, the link note prompt, and/or the web resource.

The search results interface and/or a discover interface may provide statistics on the volume of particular searches, the volume of web resource selections, and/or trends in link and/or search query interactions.

In some implementations, the systems and methods can include training and/or leveraging one or more contribution propensity models. The contribution propensity model can learn and/or determine user credibility for a particular user and/or a particular set of users (e.g., their relevant experience, expertise, and/or trustworthiness). Additionally and/or alternatively, the contribution propensity model can learn and/or determine a propensity to provide a link note.

The contribution propensity model may be trained to detect likelihood to contribute, credibility, utility of note, and/or other attributes associated with the user, the web resource, and/or the context. The contribution propensity model may be trained on labeled datasets, based on unlabeled datasets, and/or based on a hybrid dataset. In some implementations, the contribution propensity model may be trained on interaction data for learning contribution prediction tasks, may be trained on outputs from a verification model for a credibility determination tasks, and/or may be trained on click rates for utility determination tasks.

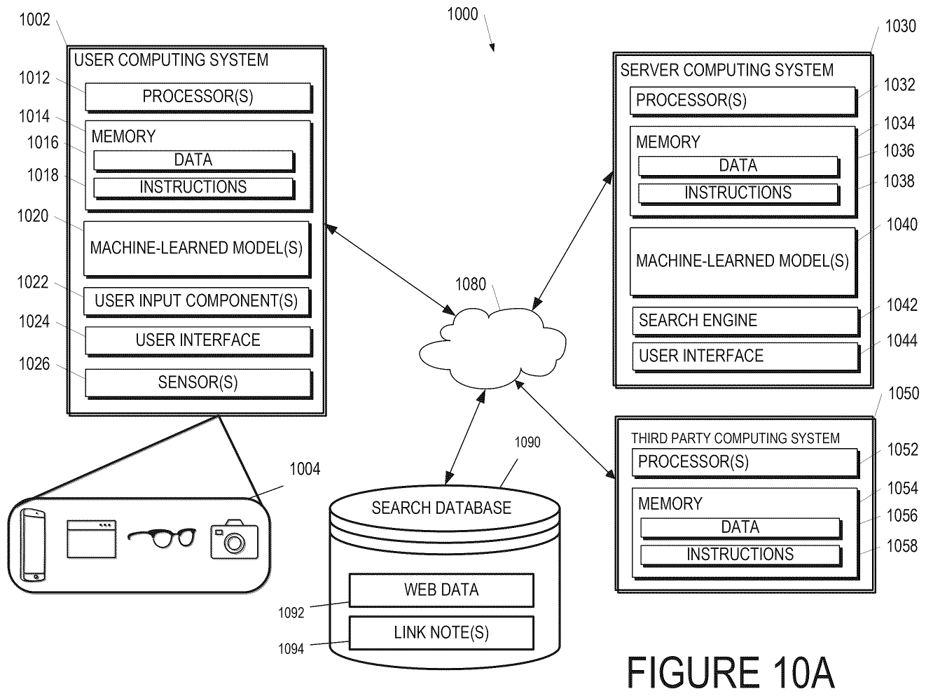

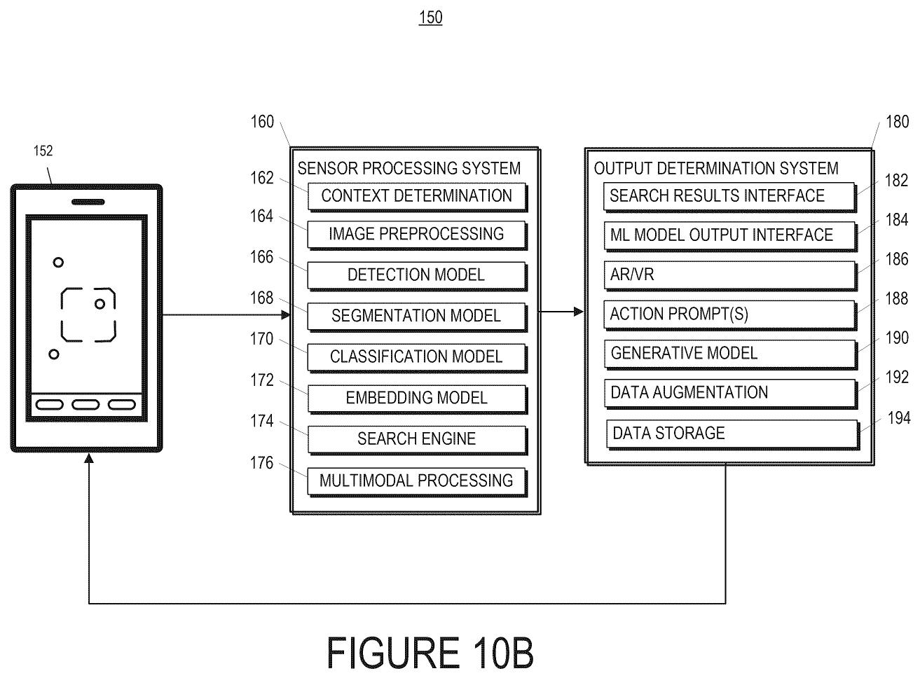

FIG. 10A depicts a block diagram of an example computing system 1000 that performs audience-based content modification according to example embodiments of the present disclosure. The system 1000 includes a user computing system 1002, a server computing system 1030, and/or a third party computing system 1050 that are communicatively coupled over a network 1080. Additionally and/or alternatively, the user computing system 1002, a server computing system 1030, and/or a third party computing system 1050 can leverage the network 1080 to access and search a search database 1090 to perform one or more search processing tasks. In some implementations, the search database 1090 may be part of and/or communicatively connected to the server computing system 1030.

The user computing system 1002 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 1002 includes one or more processors 1012 and a memory 1014. The one or more processors 1012 can be any suitable processing device (e.g., a processor core, a microprocessor, an ASIC, a FPGA, a controller, a microcontroller, etc.) and can be one processor or a plurality of processors that are operatively connected. The memory 1014 can include one or more non-transitory computer-readable storage mediums, such as RAM, ROM, EEPROM, EPROM, flash memory devices, magnetic disks, etc., and combinations thereof. The memory 1014 can store data 1016 and instructions 1018 which are executed by the processor 1012 to cause the user computing system 1002 to perform operations.

In some implementations, the user computing system 1002 can store or include one or more machine-learned models 1020. For example, the machine-learned models 1020 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 1020 can be received from the server computing system 1030 over network 1080, stored in the user computing device memory 1014, and then used or otherwise implemented by the one or more processors 1012. In some implementations, the user computing system 1002 can implement multiple parallel instances of a single machine-learned model 1020 (e.g., to perform parallel machine-learned model processing across multiple instances of input data and/or detected features).

More particularly, the one or more machine-learned models 1020 may include one or more detection models, one or more classification models, one or more segmentation models, one or more augmentation models, one or more generative models, one or more natural language processing models, one or more optical character recognition models, and/or one or more other machine-learned models. The one or more machine-learned models 1020 can include one or more transformer models. The one or more machine-learned models 1020 may include one or more neural radiance field models, one or more diffusion models, and/or one or more autoregressive language models.

The one or more machine-learned models 1020 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 1020 can process image data, text data, audio data, and/or latent encoding data to generate output data that can include image data, text data, audio data, and/or latent encoding data. The one or more machine-learned models 1020 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, ARXIV: 2202.09368v2 (October 104, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

Additionally or alternatively, one or more machine-learned models 1040 can be included in or otherwise stored and implemented by the server computing system 1030 that communicates with the user computing system 1002 according to a client-server relationship. For example, the machine-learned models 1040 can be implemented by the server computing system 1030 as a portion of a web service (e.g., a viewfinder service, a visual search service, an image processing service, an ambient computing service, and/or an overlay application service). Thus, one or more models 1020 can be stored and implemented at the user computing system 1002 and/or one or more models 1040 can be stored and implemented at the server computing system 1030.

The user computing system 1002 can also include one or more user input components 1022 that receives user input. For example, the user input component 1022 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system 1002 can store and/or provide one or more user interfaces 1024, which may be associated with one or more applications. The one or more user interfaces 1024 can be configured to receive inputs and/or provide data for display (e.g., image data, text data, audio data, one or more user interface elements, an augmented-reality experience, a virtual reality experience, and/or other data for display. The user interfaces 1024 may be associated with one or more other computing systems (e.g., server computing system 1030 and/or third party computing system 1050). The user interfaces 1024 can include a viewfinder interface, a search interface, a generative model interface, a social media interface, and/or a media content gallery interface.

The user computing system 1002 may include and/or receive data from one or more sensors 1026. The one or more sensors 1026 may be housed in a housing component that houses the one or more processors 1012, the memory 1014, and/or one or more hardware components, which may store, and/or cause to perform, one or more software packets. The one or more sensors 1026 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 1002 may include, and/or be part of, a user computing device 1004. The user computing device 1004 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more user computing devices 1004. For example, a camera of a smartphone may be utilized to capture image data descriptive of the environment, and/or an overlay application of the user computing device 1004 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 1030 includes one or more processors 1032 and a memory 1034. The one or more processors 1032 can be any suitable processing device (e.g., a processor core, a microprocessor, an ASIC, a FPGA, a controller, a microcontroller, etc.) and can be one processor or a plurality of processors that are operatively connected. The memory 1034 can include one or more non-transitory computer-readable storage mediums, such as RAM, ROM, EEPROM, EPROM, flash memory devices, magnetic disks, etc., and combinations thereof. The memory 1034 can store data 1036 and instructions 1038 which are executed by the processor 1032 to cause the server computing system 1030 to perform operations.

In some implementations, the server computing system 1030 includes or is otherwise implemented by one or more server computing devices. In instances in which the server computing system 1030 includes plural server computing devices, such server computing devices can operate according to sequential computing architectures, parallel computing architectures, or some combination thereof.

As described above, the server computing system 1030 can store or otherwise include one or more machine-learned models 1040. For example, the models 1040 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 1040 are discussed with reference to FIG. 10B.

Additionally and/or alternatively, the server computing system 1030 can include and/or be communicatively connected with a search engine 1042 that may be utilized to crawl one or more databases (and/or resources) (e.g., the search database 1090). The search engine 1042 can process data from the user computing system 1002, the server computing system 1030, and/or the third party computing system 1050 to determine one or more search results associated with the input data. The search engine 1042 may perform term based search, label based search, Boolean based searches, image search, embedding based search (e.g., nearest neighbor search), multimodal search, and/or one or more other search techniques.

The server computing system 1030 may store and/or provide one or more user interfaces 1044 for obtaining input data and/or providing output data to one or more users. The one or more user interfaces 1044 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 1002 and/or the server computing system 1030 can train the models 1020 and/or 1040 via interaction with the third party computing system 1050 that is communicatively coupled over the network 1080. The third party computing system 1050 can be separate from the server computing system 1030 or can be a portion of the server computing system 1030. Alternatively and/or additionally, the third party computing system 1050 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

Training and/or tuning can include processing, using one or more machine-learned models, the training instance to generate an output. The output can be directly obtained from the one or more machine-learned models or can be a downstream result of a chain of processing operations that includes an output of the one or more machine-learned models.

Training and/or tuning can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

Training and/or tuning can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Training and/or tuning can include implementing a number of generalization techniques (e.g., weight decays, dropouts, etc.) to improve the generalization capability of the models being trained.

In some implementations, the above training loop can be implemented for training a machine-learned model from an initialized state to a fully trained state (e.g., when the model exhibits a desired performance profile, such as based on accuracy, precision, recall, etc.).

In some implementations, the above training loop can be implemented for particular stages of a training procedure. For instance, in some implementations, the above training loop can be implemented for pre-training a machine-learned model. Pre-training can include, for instance, large-scale training over potentially noisy data to achieve a broad base of performance levels across a variety of tasks/data types. In some implementations, the above training loop can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

In some implementations, the computing system 1000 may leverage reviews and/or other user-generated content (e.g., link notes) for training and/or model-inference. For example, a user-generated link note can include details provided by a particular user discussing the web resource associated with a particular search result, which the machine-learned model (e.g., 1020 and/or 1040) can process to identify one or more predicted actions associated with that web resource. The details can include information associated with the quality of the web resource, landing pages utilized, and/or actions performed. A link note can include text provided with the search result information of a search result (e.g., the link note may be provided with the web resource title, hyperlink, and caption). In some implementations, the link note can include a multimodal user-generated content item that may include text overlayed a graphical card with one or more media content items (e.g., images and/or videos).

In training, the computing system 1000 may utilize reviews and/or other user-generated content as quality signals and/or content indicators for training the machine-learned model (e.g., 1020 and/or 1040). For example, the reviews and/or other user-generated content can include details associated with how a user utilized the web page, what they saw on the web page, and/or their review of the quality of that web resource. The computing system 1000 may process the details of the reviews and/or other user-generated content to generate labels for web resources (e.g., a machine-learned model (e.g., 1020 and/or 1040) may process the details to identify particular actions discussed in the reviews and/or other user-generated content), and the labels may then be utilized for machine-learned model training. Alternatively and/or additionally, the computing system 1000 may utilize the reviews and/or other user-generated content as input and/or for input conditioning during training. Moreover, the machine-learned model (e.g., 1020 and/or 1040) may process the reviews and/or other user-generated content during model-inference to determine, rank, and/or filter predicted actions.

Additionally and/or alternatively, the search results interface may provide one or more link notes for display with the shortcut to the resource locator. The one or more link notes may be general link notes associated with the particular web resource. Alternatively and/or additionally, the one or more link notes may be selected based on the content of the landing page associated with the shortcut (e.g., link notes associated with reserving a table may be identified and provided for display based on the shortcut being associated with a landing page for booking a table at the restaurant associated with the web resource).

In some implementations, the computing system 1000 may utilize one or more soft prompts for conditioning the one or more machine-learned models (120 and/or 1040) for downstream tasks. The one or more soft prompts can include a set of tunable parameters that can be trained (or tuned) as the parameters of the one or more machine-learned models (120 and/or 1040) are fixed. The one or more soft prompts 1024 can be trained for a specific task and/or a specific set of tasks. Alternatively and/or additionally, the one or more soft prompts 1024 may be trained to condition the one or more machine-learned models (120 and/or 1040) to perform inferences for a particular individual, one or more entities, and/or one or more tasks such that the output is tailored for that particular individual, particular entities, and/or particular task. The one or more soft prompts 1024 can be obtained and processed with one or more inputs by the one or more machine-learned models (120 and/or 1040).

The one or more soft prompts can include a set of machine-learned weights. In particular, the one or more soft prompts can include weights that were trained to condition a generative model to generate model-generated content with one or more particular attributes. For example, the one or more soft prompts can be utilized by a user to generate content based on the fine-tuning. The one or more soft prompts can be extended to a plurality of tasks. For example, the computing system 1000 may tune the set of parameters on a plurality of different content attributes and/or types. The one or more soft prompts may include a plurality of learned vector representations that may be model-readable.

A particular soft prompt can be obtained based on a particular task, individual, content type, etc. The particular soft prompt can include a set of learned parameters. The set of learned parameters can be processed with the generative model to generate the model-generated image.

The user computing system 1002 and/or the server computing system 1030 may store one or more soft prompts associated with the particular user and/or particular task. The soft prompt(s) can include a set of parameters. The user computing system 1002 and/or the server computing system 1030 may leverage the set of parameters of the soft prompt(s) and a generative model to generate a model-generated content item. In some implementations, the model-generated content item can be generated based on the set of parameters associated with the particular individual and/or task.

The utilization of a soft prompt (i.e., a set of parameters that can be processed with a generative model for downstream task conditioning) can reduce the computational cost for parameter tuning for object-specific content generation by reducing the parameters to be tuned. The set of parameters can be limited and may be adjusted while the parameters of the pre-trained generative model stay fixed. The set of parameters of the soft prompt can be utilized to condition the pre-trained generative model (e.g., the machine-learned image generation model and/or language model) for particular downstream tasks (e.g., response generation and/or image rendering).

In some implementations, the generative language model and/or one or more soft prompts (e.g., a set of machine-learned parameters that can be processed with the input by the generative language model) can be trained to generate content with particular attributes.

In some implementations, the server computing system 1030 can include a prompt library. The prompt library can store a plurality of prompt templates (e.g., a plurality of hard prompt templates (e.g., text prompt templates)) and/or a plurality of soft prompts. The plurality of prompt templates can include hard prompt templates (e.g., text string data) that may be combined with the user input to generate a more detailed and complete prompt for the generative model to process. The templates can include text descriptive of the request. The templates may be object-specific, user-specific, and/or content-specific. The plurality of prompt templates may include few-shot examples.

The prompt library can store a plurality of soft prompts. The plurality of soft prompts may be associated with a plurality of different content attributes and/or a plurality of different individuals. The plurality of soft prompts can include learned parameters and/or learned weights that can be processed with the generative model to condition the generative model to generate content items with particular attributes. The plurality of soft prompts may have been tuned by freezing the parameters of a pre-trained generative model, while the parameters of the soft prompt are learned based on a particular task and/or user. The plurality of soft prompts can include a plurality of different soft prompts associated with a plurality of different users and/or a plurality of different sets of users.

The third party computing system 1050 can include one or more processors 1052 and a memory 1054. The one or more processors 1052 can be any suitable processing device (e.g., a processor core, a microprocessor, an ASIC, a FPGA, a controller, a microcontroller, etc.) and can be one processor or a plurality of processors that are operatively connected. The memory 1054 can include one or more non-transitory computer-readable storage mediums, such as RAM, ROM, EEPROM, EPROM, flash memory devices, magnetic disks, etc., and combinations thereof. The memory 1054 can store data 1056 and instructions 1058 which are executed by the processor 1052 to cause the third party computing system 1050 to perform operations. In some implementations, the third party computing system 1050 includes or is otherwise implemented by one or more server computing devices.

The network 1080 can be any type of communications network, such as a local area network (e.g., intranet), wide area network (e.g., Internet), or some combination thereof and can include any number of wired or wireless links. In general, communication over the network 1080 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The network 1080 can be utilized to access one or more search databases 1090 to perform one or more search-based tasks, which may include web searches, image searches, blockchain searches, image searches, reverse image searches, embedding searches, and/or other searches. The one or more search databases 1090 can store web data 1092 to be leveraged to determine search results relevant (e.g., responsive) to a search query. The web data 1092 can include data descriptive of uniform resource locators, content snippets, cached data, classification labels for the content of a web resource, tags, embeddings associated with web resources, knowledge graphs, titles, authors, content types, and/or other relevant data that may be indexed to determine the topic, content, sentiment, intent, and/or other features of a web resource to then be leveraged for search instances.

The web data 1092 can be leveraged to determine search results responsive to a search query. The server computing system 1030 (and/or the user computing system 1002) can then render a search results interface based on the determined search results. The search results interface can include a search result list, a search result grid, a knowledge panel, search result categories, search result tabs, and/or other user interface configurations and/or elements. The search results interface may display text (e.g., titles and text snippets), hyperlinks, images, videos, audio, animations, carousels, and/or other data.

In some implementations, the search results interface may display one or more link notes 1094 associated with the one or more search results. The one or more link notes 1094 may be associated with respective web resources that were determined to be responsive to the search query. The link notes 1094 may be stored by the search database 1090, which may include indexing the respective link notes 1094 with other index data for the respective web resources.

Link notes 1094 can include user-generated content that was generated (e.g., composed) to be responsive to and/or about a particular web resource. For example, a link note 1094 may include a review of the content of a web resource (e.g., a review of a story published on a particular web page). The link note 1094 may include details about the web resource provided by one or more users, which may include a breakdown of related topics, a discussion on the credibility of the web resource, a discussion of related works, and/or other details. Link notes 1094 can include text, one or more images, one or more videos, audio, multimodal data, and/or other data. Link notes 1094 can include graphical cards that may include a background and structured foreground content, which may include text, image(s), video(s), widget(s), link(s), animation(s), and/or other data.

Link notes 1094 may be generated based on prompt suggestions provided to a user, which a user may then leverage to craft a link note graphical card. The computing system 1000 can leverage context determination (e.g., determining a context a user is likely to provide a note and/or determining a comment gap and/or content gap for a particular link) to determine an input entry interface (e.g., a link note input entry interface) is to be provided and can leverage a generative model (e.g., a large language model) to generate a prompt based on user data (e.g., user search history and/or user browsing history) and/or content data (e.g., the topic of the content and/or the type of content). For example, a user may be prompted in a search results page, during web resource review, and/or upon next search instance to provide a note on a particular web resource (and/or other content item). A prompt can be generated based on previous user notes, previously viewed content, the topic of the content, and/or the type of content to provide the user with a prompt that requests information in a format that causes insightful note generation.

Link notes 1094 can provide additional information on a web resource without reviewing the web resource, and the link notes can be provided by other users. The computing system 1000 can determine when to provide link notes prompts to users based on contexts determined to be associated with valuable note intake. For example, particular users may provide more trustworthy and/or more detailed information on a particular topic based on previously obtained knowledge and/or based on previously generated notes. Additionally and/or alternatively, particular content types may be determined to be associated with user commenting and/or user confusion.

The prompt provided to the user can “inspire” a user to provide more detailed information and/or may direct a user to leave a note on a particular topic and/or feature of the web resource. A generative model can process user data and/or content data to generate a predicted prompt. In particular, the generative model can leverage a user's search history, a user's browsing history, a user's previous notes, and/or other user data to generate suggested notes, a question to prompt response, and/or a note template. Alternatively and/or additionally, the generative model can leverage semantic understanding of the web resource, topic classification, content type classification, other notes associated with the web resource, and/or other content data to generate suggested notes, a question to prompt response, and/or a note template.

An input entry interface can provide the predicted prompt to a user. The input entry interface can then obtain inputs (e.g., comment input data) from a user to generate user-generated content descriptive of a link note 1094. In some implementations, a graphical card can be generated based on the link note 1094. The graphical card can include the user-generated content of the link note, user profile identifiers (e.g., a name and/or an image), link information, and/or a graphical background. The link note 1094 (and/or the graphical card) can be stored with an association with the web resource. The stored link note 1094 (and/or the graphical card) can then be obtained in response to one or more users searching for the web resource and/or one or more users interacting with a notes interface.

Link notes 1094 (e.g., link notes obtained from users and/or link notes generated by a generative model) can provide additional information on a web resource, which may inform other users of a relevancy to their request. The link notes 1094 can be provided in a search results page and/or may be displayed in a notes interface that can be accessed from a search results page and/or from the web resource. Link notes 1094 can be provided in graphical cards, in a text panel in-line with a text snippet, and/or in other formats.

In some implementations, the link notes 1094 and/or interactions with the link notes 1094 may be utilized to adjust web resource rankings, web resource tagging, web resource embedding, and/or web resource indexing. For example, in some implementations, the link notes 1094 can be processed to determine the quality of the web resource. The quality determination may be determined based on processing the link notes with one or more machine-learned models (e.g., a sentiment analysis model, a language model, a classification model, etc.). The link notes 1094 may be processed with one or more machine-learned models to determine topics associated with the web resource, determine biases of the web resource, utility of the web resource, and/or the direction of the web resource. The link notes 1094 may be utilized for suggesting additional content, may be embedded for embedding based searches, and/or may be utilized for query suggestions.

Link notes 1094 in the notes interface may be ranked and/or displayed based on interactions, machine-learned model determined quality, responsiveness to a query, a level of detail, and/or other attributes. In some implementations, link notes 1094 generated by a user may be provided to all other users, only users within the user's social network, and/or only user's determined to be associated with the user based on interests, location, and/or activity.

Link notes 1094 can be utilized for a plurality of different content items and may not be limited to web resources. For example, the computing system 1000 can be utilized to generate prompts and/or interfaces for obtaining, inspiring, and/or generating link notes for local files (e.g., on-device documents, images, videos, etc.), intranet files, and/or other content item sources, which may include folders on an external drive, documents on the cloud, etc.

In some implementations, the input interface can include an open ended input interface that provides one or more options for providing user inputs. Alternatively and/or additionally, the input interface can include a plurality of features and/or options for generating user-generated content, which may be utilized for link notes and/or stand alone content. The input interface can include an independent content item user interface that can enable a user to add images, links, and/or different template types of content and can be interactive. The interactive user interface can include an image suggestion, template suggestion, text suggestion, layout suggestion, link suggestion, widget suggestions, template suggestion, and/or other options (e.g., other types of suggestions).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the task can be a generative task, and the one or more machine-learned models (e.g., 1020 and/or 1040) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system may include a number of applications (e.g., applications 10 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 1002 can include a number of applications (e.g., applications 10 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing system 1000.

The central intelligence layer can communicate with a central device data layer. The central device data layer can be a centralized repository of data for the computing system 1000. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 10B depicts a block diagram of an example computing system 150 that performs audience-based content modification according to example embodiments of the present disclosure. In particular, the example computing system 150 can include one or more computing devices 152 that can be utilized to obtain, and/or generate, one or more datasets that can be processed by a sensor processing system 160 and/or an output determination system 180 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 152 (e.g., one or more sensors in the computing device 152). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 152 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 160. The sensor processing system 160 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 162, which may determine a context associated with one or more content items. The context determination block 162 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 160 may include an image preprocessing block 164. The image preprocessing block 164 may be utilized to adjust one or more values of an obtained and/or received image to prepare the image to be processed by one or more machine-learned models and/or one or more search engines 174. The image preprocessing block 164 may resize the image, adjust saturation values, adjust resolution, strip and/or add metadata, and/or perform one or more other operations.

In some implementations, the sensor processing system 160 can include one or more machine-learned models, which may include a detection model 166, a segmentation model 68, a classification model 170, an embedding model 172, and/or one or more other machine-learned models. For example, the sensor processing system 160 may include one or more detection models 166 that can be utilized to detect particular features in the processed dataset. In particular, one or more images can be processed with the one or more detection models 166 to generate one or more bounding boxes associated with detected features in the one or more images.

Additionally and/or alternatively, one or more segmentation models 168 can be utilized to segment one or more portions of the dataset from the one or more datasets. For example, the one or more segmentation models 168 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 170 can be utilized to process image data, text data, audio data, latent encoding data, multimodal data, and/or other data to generate one or more classifications. The one or more classification models 170 can include one or more image classification models, one or more object classification models, one or more text classification models, one or more audio classification models, and/or one or more other classification models. The one or more classification models 170 can process data to determine one or more classifications.

In some implementations, data may be processed with one or more embedding models 172 to generate one or more embeddings. For example, one or more images can be processed with the one or more embedding models 172 to generate one or more image embeddings in an embedding space. The one or more image embeddings may be associated with one or more image features of the one or more images. In some implementations, the one or more embedding models 172 may be configured to process multimodal data to generate multimodal embeddings. The one or more embeddings can be utilized for classification, search, and/or learning embedding space distributions.

The sensor processing system 160 may include one or more search engines 174 that can be utilized to perform one or more searches. The one or more search engines 174 may crawl one or more databases (e.g., one or more local databases, one or more global databases, one or more private databases, one or more public databases, one or more specialized databases, and/or one or more general databases) to determine one or more search results. The one or more search engines 174 may perform feature matching, text based search, embedding based search (e.g., k-nearest neighbor search), metadata based search, multimodal search, web resource search, image search, text search, and/or application search.

Additionally and/or alternatively, the sensor processing system 160 may include one or more multimodal processing blocks 176, which can be utilized to aid in the processing of multimodal data. The one or more multimodal processing blocks 176 may include generating a multimodal query and/or a multimodal embedding to be processed by one or more machine-learned models and/or one or more search engines 174.

The output(s) of the sensor processing system 160 can then be processed with an output determination system 180 to determine one or more outputs to provide to a user. The output determination system 180 may include heuristic based determinations, machine-learned model based determinations, user selection based determinations, and/or context based determinations.

The output determination system 180 may determine how and/or where to provide the one or more search results in a search results interface 182. Additionally and/or alternatively, the output determination system 180 may determine how and/or where to provide the one or more machine-learned model outputs in a machine-learned model output interface 184. In some implementations, the one or more search results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 160 may be utilized to generate and/or provide an augmented-reality experience and/or a virtual-reality experience 186. For example, the one or more obtained datasets may be processed to generate one or more augmented-reality rendering assets and/or one or more virtual-reality rendering assets, which can then be utilized to provide an augmented-reality experience and/or a virtual-reality experience 186 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 188 may be determined based on the output(s) of the sensor processing system 160. For example, a search prompt, a purchase prompt, a generate prompt, a reservation prompt, a call prompt, a redirect prompt, and/or one or more other prompts may be determined to be associated with the output(s) of the sensor processing system 160. The one or more action prompts 188 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 160 may be processed with one or more generative models 190 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 190 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 190 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 190 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 190 can be trained to process input data and generate model-generated content items, which may include a plurality of predicted words, pixels, signals, and/or other data. The model-generated content items may include novel content items that are not the same as any pre-existing work. The one or more generative models 190 can leverage learned representations, sequences, and/or probability distributions to generate the content items, which may include phrases, storylines, settings, objects, characters, beats, lyrics, and/or other aspects that are not included in pre-existing content items.

The one or more generative models 190 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 190 may be stored on-device and/or may be stored on a server computing system. In some implementations, the one or more generative models 190 can perform on-device processing to determine suggested searches, suggested actions, and/or suggested prompts. The one or more generative models 190 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 190 can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

Sequence processing models can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 106×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing models can process one or multiple types of data simultaneously. Sequence processing models can include relatively large models (e.g., more parameters, computationally expensive, etc.), relatively small models (e.g., fewer parameters, computationally lightweight, etc.), or both.

In general, sequence processing models can obtain an input sequence using data from inputs. For instance, input sequence can include a representation of data from inputs 2 in a format understood by sequence processing models. One or more machine-learned components of sequence processing models can ingest the data from inputs, parse the data into pieces compatible with the processing architectures of sequence processing models (e.g., via “tokenization”), and project the pieces into an input space associated with prediction layers (e.g., via “embedding”).

Sequence processing models can ingest the data from inputs and parse the data into a sequence of elements to obtain input sequence. For example, a portion of input data from inputs can be broken down into pieces that collectively represent the content of the portion of the input data. The pieces can provide the elements of the sequence.

In some implementations, processing the input data can include tokenization. For example, a tokenizer may process a given portion of an input source and output a series of tokens (e.g., corresponding to input elements) that represent the portion of the input source. Various approaches to tokenization can be used. For instance, textual input sources can be tokenized using a byte-pair encoding (BPE) technique. See, e.g., Kudo et al., Sentence Piece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input sources can be tokenized by extracting and serializing patches from an image.

In general, arbitrary data types can be serialized and processed into an input sequence.

Prediction layers can predict one or more output elements based on the input elements. Prediction layers can include one or more machine-learned model architectures, such as one or more layers of learned parameters that manipulate and transform the inputs to extract higher-order meaning from, and relationships between, input elements. In this manner, for instance, example prediction layers can predict new output elements in view of the context provided by input sequence.

Prediction layers can evaluate associations between portions of input sequence and a particular output element. These associations can inform a prediction of the likelihood that a particular output follows the input context. For example, consider the textual snippet, “The carpenter's toolbox was small and heavy. It was full of ______.” Example prediction layers can identify that “It” refers back to “toolbox” by determining a relationship between the respective embeddings. Example prediction layers can also link “It” to the attributes of the toolbox, such as “small” and “heavy.” Based on these associations, prediction layers can, for instance, assign a higher probability to the word “nails” than to the word “sawdust.”

A transformer is an example architecture that can be used in prediction layers. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence and potentially one or more output elements. A transformer block can include one or more attention layers and one or more post-attention layers (e.g., feedforward layers, such as a multi-layer perceptron).

Prediction layers can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layers can leverage various kinds of artificial neural networks that can understand or generate sequences of information.

Output sequence can include or otherwise represent the same or different data types as input sequence. For instance, input sequence can represent textual data, and output sequence can represent textual data. The input sequence can represent image, audio, or audiovisual data, and output sequence can represent textual data (e.g., describing the image, audio, or audiovisual data). It is to be understood that prediction layers, and any other interstitial model components of sequence processing models, can be configured to receive a variety of data types in input sequences and output a variety of data types in output sequences.

The output sequence can have various relationships to an input sequence. Output sequence can be a continuation of input sequence. The output sequence can be complementary to the input sequence. The output sequence can translate, transform, augment, or otherwise modify input sequence. The output sequence can answer, evaluate, confirm, or otherwise respond to input sequence. The output sequence can implement (or describe instructions for implementing) an instruction provided via an input sequence.

The output sequence can be generated autoregressively. For instance, for some applications, an output of one or more prediction layers can be passed through one or more output layers (e.g., softmax layer) to obtain a probability distribution over an output vocabulary (e.g., a textual or symbolic vocabulary) conditioned on a set of input elements in a context window. In this manner, for instance, the output sequence can be autoregressively generated by sampling a likely next output element, adding that element to the context window, and re-generating the probability distribution based on the updated context window, and sampling a likely next output element, and so forth.

The output sequence can also be generated non-autoregressively. For instance, multiple output elements of the output sequence can be predicted together without explicit sequential conditioning on each other. See, e.g., Saharia et al., Non-Autoregressive Machine Translation with Latent Alignments, arXiv:2004.07437v3 (Nov. 16, 2020).

The output sequence can include one or multiple portions or elements. In an example content generation configuration, the output sequence can include multiple elements corresponding to multiple portions of a generated output sequence (e.g., a textual sentence, values of a discretized waveform, computer code, etc.). In an example classification configuration, the output sequence can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

The output determination system 180 may process the one or more datasets and/or the output(s) of the sensor processing system 160 with a data augmentation block 192 to generate augmented data. For example, one or more images can be processed with the data augmentation block 192 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 160 may be stored based on a data storage block 194 determination.

The output(s) of the output determination system 180 can then be provided to a user via one or more output components of the user computing device 152. For example, one or more user interface elements associated with the one or more outputs can be provided for display via a visual display of the user computing device 152.

The processes may be performed iteratively and/or continuously. One or more user inputs to the provided user interface elements may condition and/or affect successive processing loops.

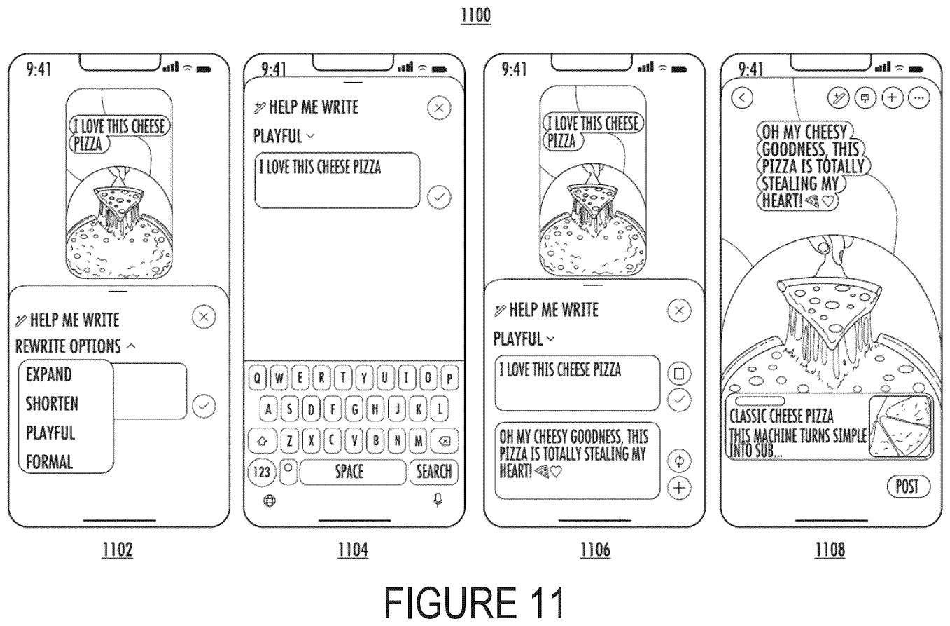

FIG. 11 depicts an illustration of example content item generation interface 1100 according to example embodiments of the present disclosure. In particular, in modifying a graphical card template, an input drafting interface may be utilized for generating one or more content items.

For example, the user may select an option to open the content item generation interface 1100. At 1102, a user may select one or more attributes from a dropdown menu. The one or more attributes can be associated with requested for attributes for the content item being generated. The one or more attributes may be associated with a tone and/or a style for the content. At 1104, a user may generate and/or provide a text input. The text input can be associated with a topic, intent, information, and/or other prompt details. The one or more attributes and the text input can be processed with a generative model to generate a model-generated content item. The model-generated content item can have the one or more attributes and may be directed to the topic, intent, information, and/or other prompt details of the text input.

At 1106, the model-generated content item can be provided for display below the text input and may be provided with a plurality of options. The plurality of options can include editing the one or more attributes, editing the text input, reprocessing the data, saving the mode-generated content item, exiting out of the interface, inserting the model-generated content item into the graphical card, and/or other options. At 1108, the modified graphical card can be provided for display with the model-generated content item inserted into the graphical card based on a user selection. The user may then edit the layout, size, colors, fonts, and/or orientations of the model-generated content item and/or other content of the graphical card.

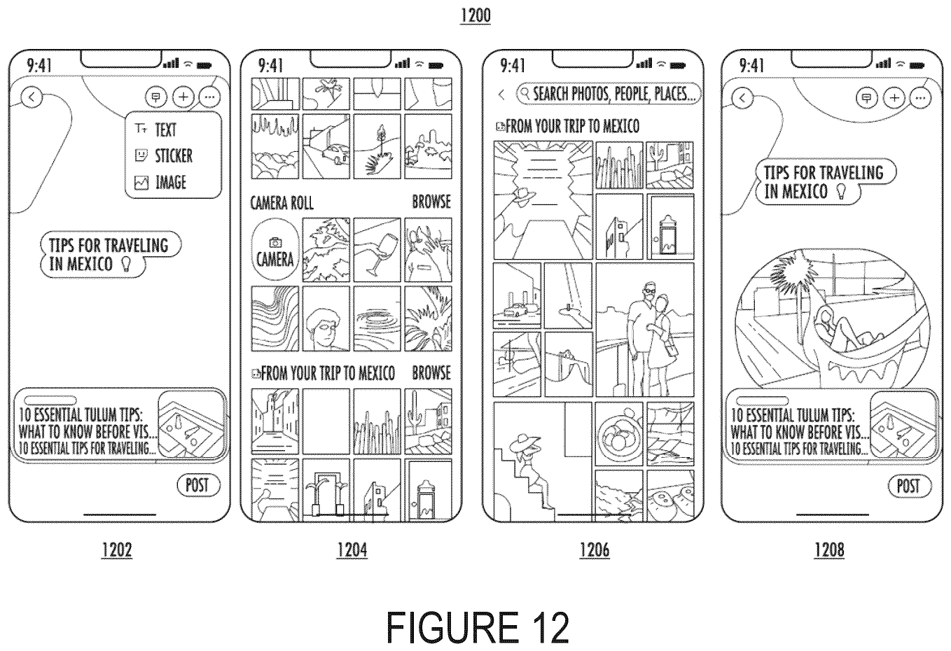

FIG. 12 depicts an illustration of example image suggestion interface 1200 according to example embodiments of the present disclosure. In particular, the image suggestion interface 1200 can obtain card data, context data, and/or input data. The card data, context data, and/or input data can then be processed to determine one or more images (and/or other media content items) to provide as suggestions for insertion in a graphical card.

For example, at 1202, a graphical card is provided for display with an option to insert additional text, a sticker, and/or an image. The user may then select the add image option. At 1204, an image selection interface can be provided for display, which can include default images, camera roll images, and/or image suggestions based on the text of the graphical card, the contents of the web resource associated with the link note, a user history, and/or other data. For example, a plurality of images from the user's image gallery may be determined to be relevant to the text of the graphical card based on determining the images are associated with a location (e.g., Mexico) that was referenced in the text of the graphical card. At 1206, the identified images can be provided for display for selection. A user may select a particular image from the identified images, which may be processed and inserted into the graphical card. At 1208, the selected image may be cropped and inserted into the graphical card for display.

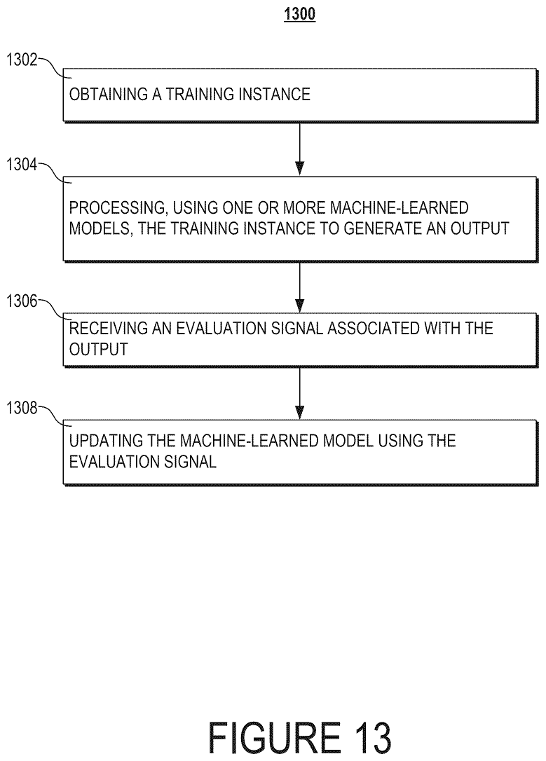

FIG. 13 depicts a flowchart of a method 1300 for training one or more machine-learned models according to aspects of the present disclosure. For instance, an example machine-learned model can include a generative language model (e.g., a large language model), an image generation model (e.g., a diffusion model), a classification model (e.g., a topic classification model and/or a linguistic characterization model), a parsing model, a tokenizer, and/or other machine-learned models.

One or more portion(s) of example method 1300 can be implemented by a computing system that includes one or more computing devices such as, for example, computing systems described with reference to the other figures. Each respective portion of example method 1300 can be performed by any (or any combination) of one or more computing devices. Moreover, one or more portion(s) of example method 1300 can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of example method 1300 can be performed additionally, or alternatively, by other systems.

At 1302, example method 1300 can include obtaining a training instance. A set of training data can include a plurality of training instances divided between multiple datasets (e.g., a training dataset, a validation dataset, or testing dataset). A training instance can be labeled or unlabeled. Although referred to in example method 1300 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1304, example method 1300 can include processing, using one or more machine-learned models, the training instance to generate an output. The output can be directly obtained from the one or more machine-learned models or can be a downstream result of a chain of processing operations that includes an output of the one or more machine-learned models.

At 1306, example method 1300 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1308, example method 1300 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1300 can include implementing a number of generalization techniques (e.g., weight decays, dropouts, etc.) to improve the generalization capability of the models being trained.

In some implementations, example method 1300 can be implemented for training a machine-learned model from an initialized state to a fully trained state (e.g., when the model exhibits a desired performance profile, such as based on accuracy, precision, recall, etc.).

In some implementations, example method 1300 can be implemented for particular stages of a training procedure. For instance, in some implementations, example method 1300 can be implemented for pre-training a machine-learned model. Pre-training can include, for instance, large-scale training over potentially noisy data to achieve a broad base of performance levels across a variety of tasks/data types. In some implementations, example method 1300 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

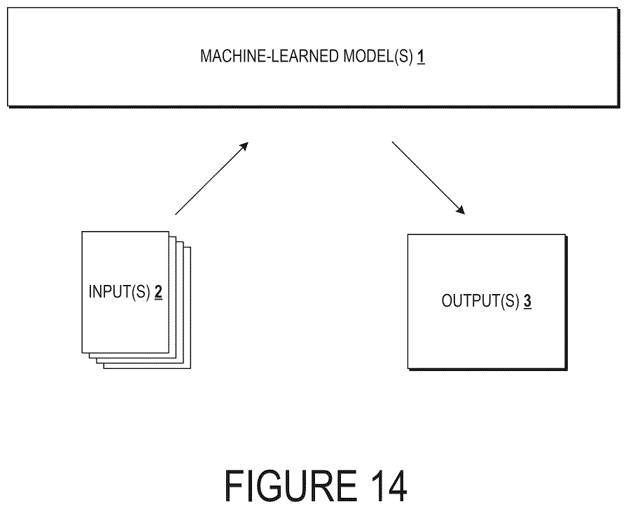

FIG. 14 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

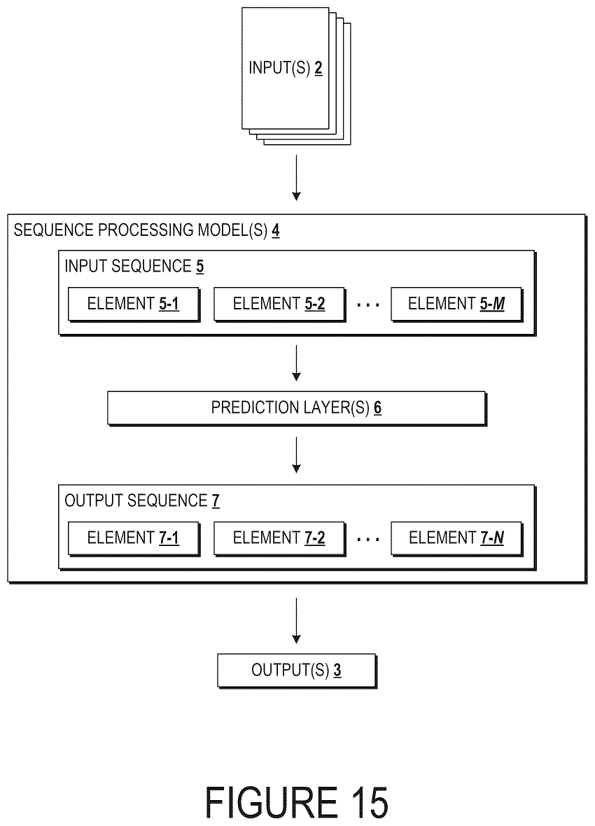

FIG. 15 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 15 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

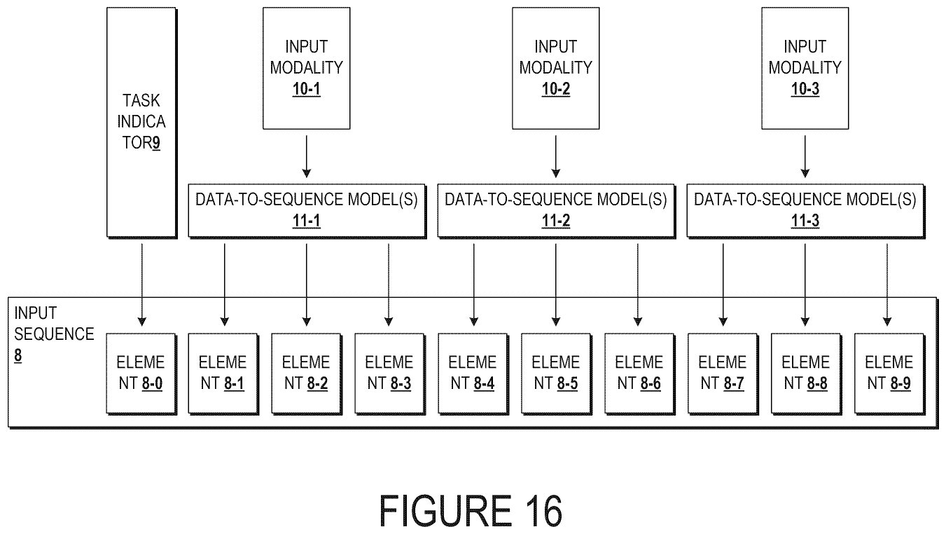

FIG. 16 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

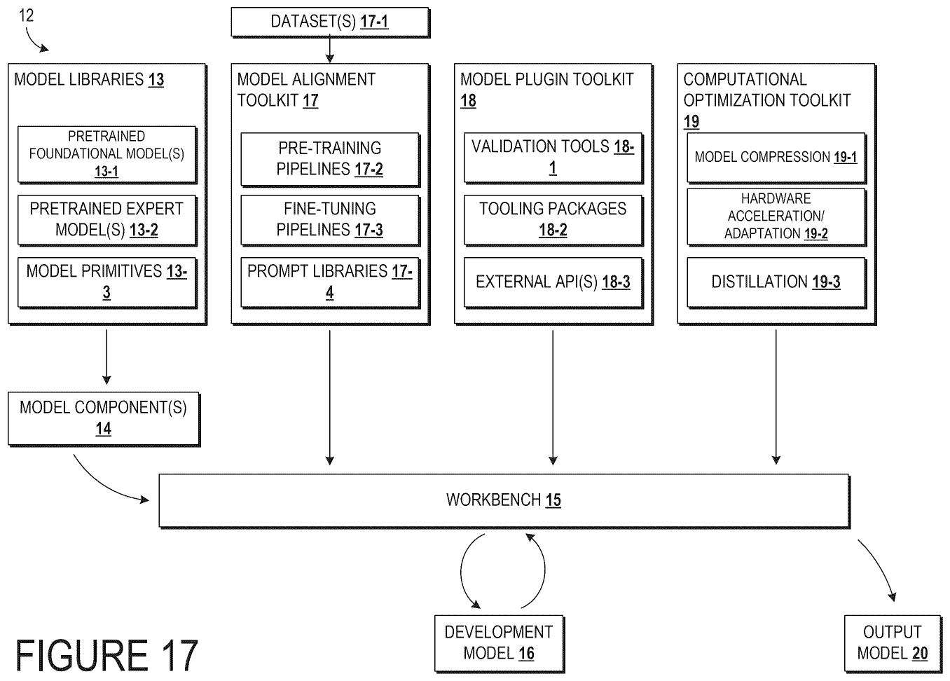

FIG. 17 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1300 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

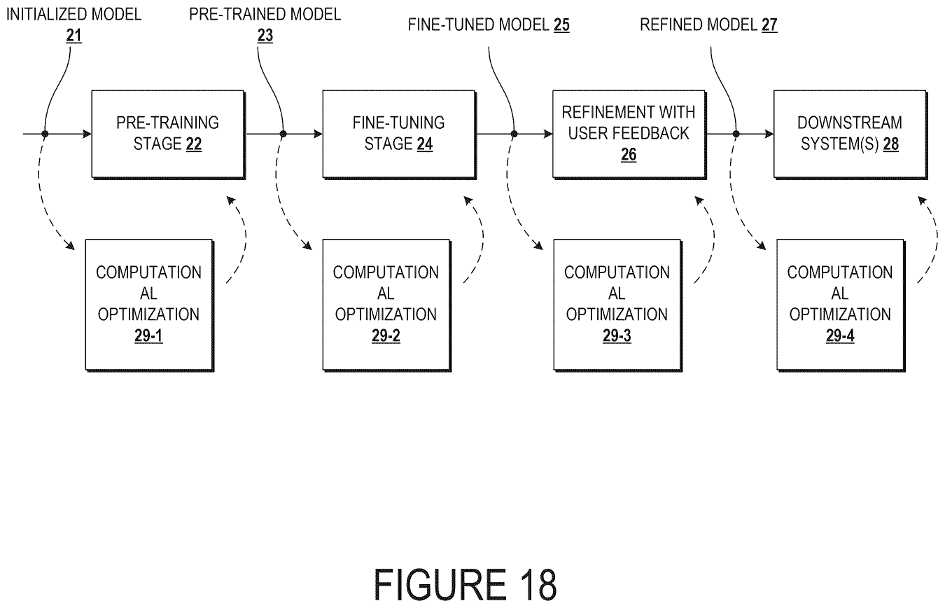

FIG. 18 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 18 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 18 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

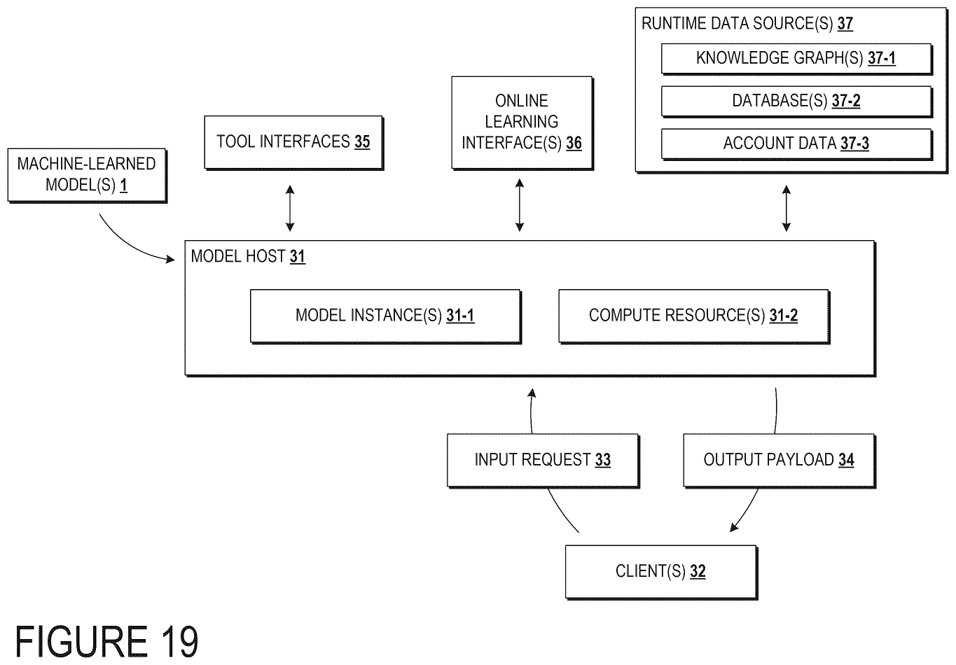

FIG. 19 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also share model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) I can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) I can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) I can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

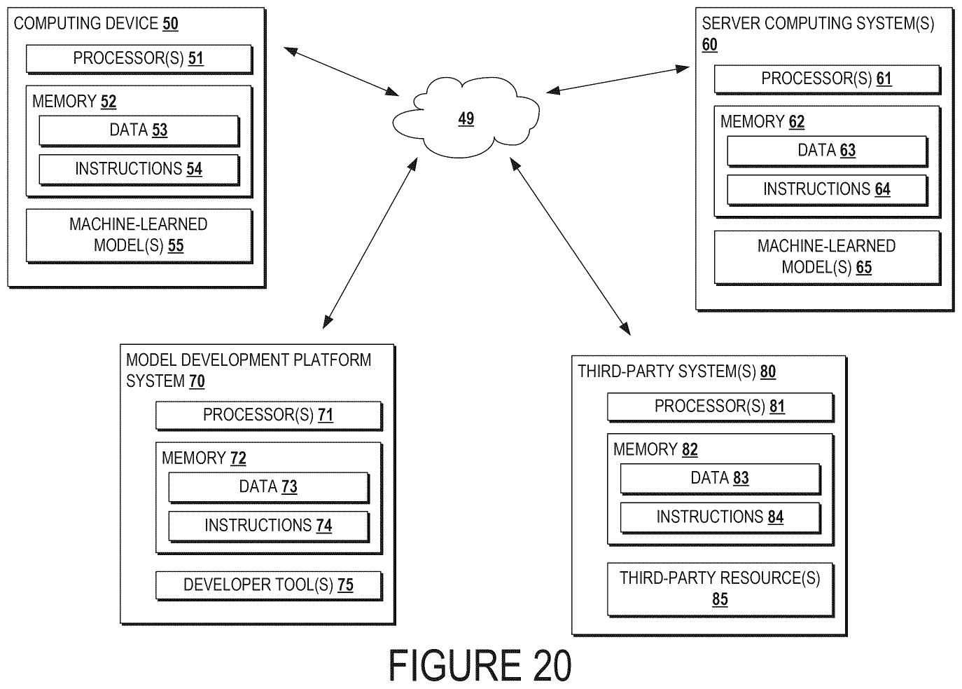

FIG. 20 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 20 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 20 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

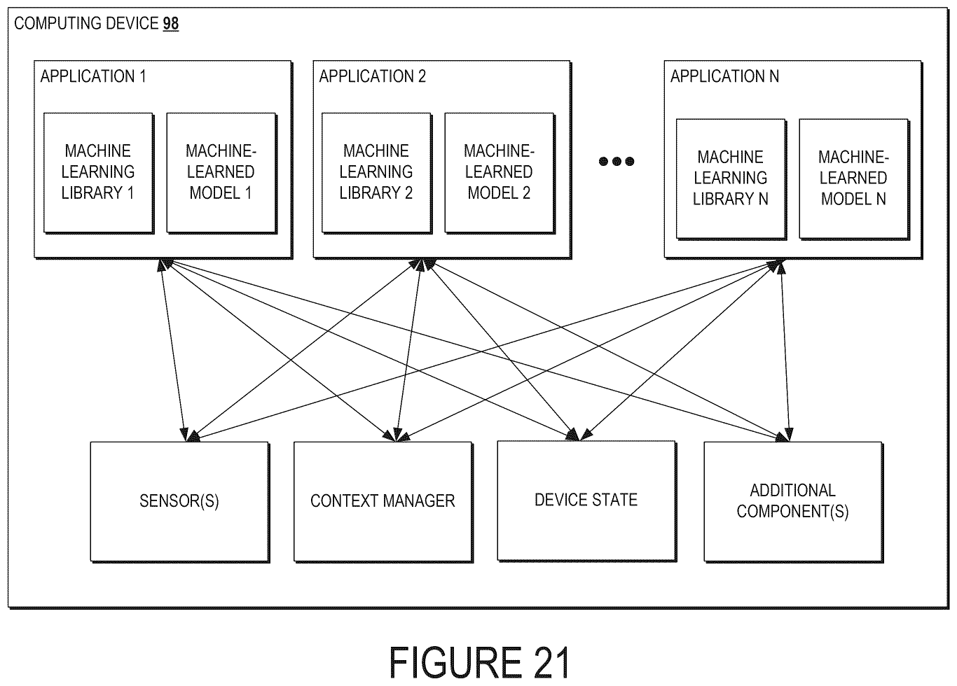

FIG. 21 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 21, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

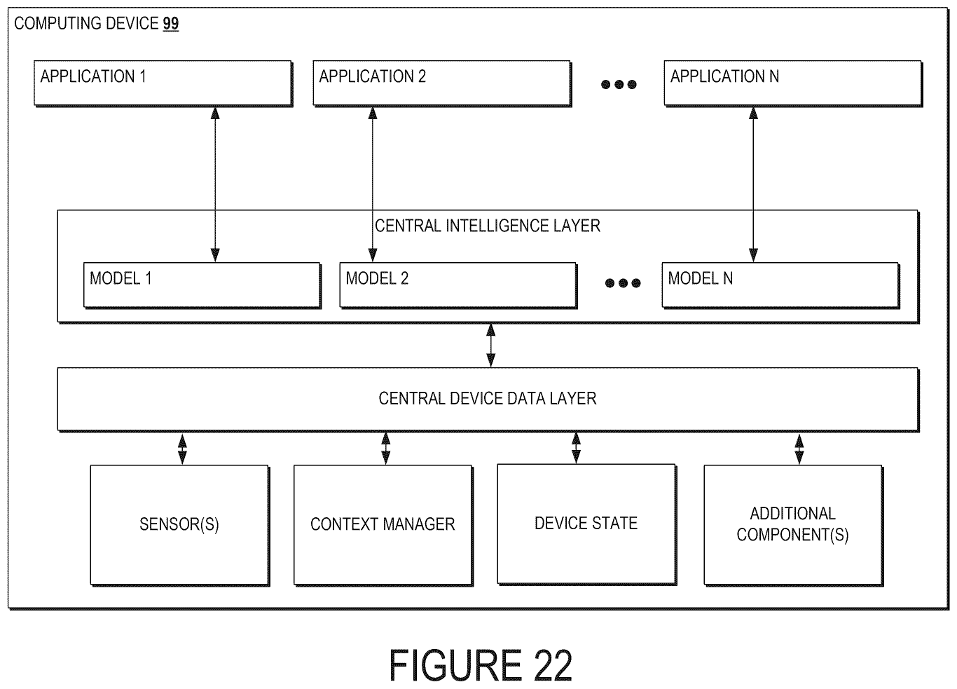

FIG. 22 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 22, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 22, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computing system for content augmentation, the system comprising:
one or more processors; and
one or more non-transitory computer-readable media that collectively store instructions that, when executed by the one or more processors, cause the computing system to perform operations, the operations comprising:
obtaining a content item to be displayed via a graphical user interface, wherein the content item comprises one or more text strings;
obtaining user profile data associated with a particular user requesting to view the graphical user interface that comprises the content item, wherein the user profile data is descriptive of characteristics of the particular user, and wherein the user profile data comprises a user-specific embedding representation comprising a plurality of machine-learned values;
determining to generate an alternative version of the content item based on the user-specific embedding representation of the user profile data and the one or more text strings of the content item;
in response to determining to generate the alternative version of the content item, processing the content item and the user-specific embedding representation of the user profile data with a generative language model to generate an alternative content item, wherein the alternative content item comprises an augmented version of the content item based on the characteristics of the particular user; and
providing the graphical user interface for display to the particular user with the content item replaced with the alternative content item.

2. The system of claim 1, wherein the operations further comprise:
processing the user profile data to determine linguistic characteristics of the particular user based on user-generated content composed by the particular user;
generating an augmentation prompt based on the linguistic characteristics, wherein the augmentation prompt conditions the generative language model to rewrite the content item to have the linguistic characteristics of the particular user; and
wherein processing the content item and the user profile data with the generative language model to generate the alternative content item comprises: processing the content item and the augmentation prompt with the generative language model.

3. The system of claim 1, wherein the operations further comprise:
determining one or more topics of the content item;
processing the user profile data to determine topic expertise of the particular user based on user-generated content composed by the particular user;
generating an augmentation prompt based on the topic expertise, wherein the augmentation prompt conditions the generative language model to rewrite the content item based on the topic expertise of the particular user; and
wherein processing the content item and the user profile data with the generative language model to generate the alternative content item comprises: processing the content item and the augmentation prompt with the generative language model.

4. The system of claim 3, wherein the topic expertise is associated with the one or more topics of the content item.

5. The system of claim 3, wherein the augmentation prompt conditions the generative language model to augment the content item to include additional topic details in response to the topic expertise being descriptive of a novice level of topic expertise.

6. The system of claim 3, wherein the augmentation prompt conditions the generative language model to augment the content item to include domain-specific terminology in response to the topic expertise being descriptive of an expert level of topic expertise.

7. The system of claim 1, wherein the content item comprises a link note, wherein the link note is descriptive of a comment left by one or more other users linked to a web resource, wherein the link note is provided for display when the web resource is provided as a search result.

8. The system of claim 1, wherein the graphical user interface comprises a search result interface.

9. The system of claim 1, wherein the operations further comprise:
obtaining a search query from a user computing device associated with the particular user;
determining a plurality of search results responsive to the search query; and
determining to provide the content item for display based on the content item being indexed with information associated with at least one of the plurality of search results.

10. The system of claim 9, wherein the content item and the user profile data are obtained in response to determining to provide the content item for display.

11. A computer-implemented method for content augmentation, the method comprising:
obtaining, by a computing system comprising one or more processors, a content item to be displayed via a graphical user interface, wherein the content item comprises one or more text strings;
obtaining, by the computing system, historical user data associated with a particular user requesting to view the graphical user interface that comprises the content item, wherein the historical user data is descriptive of linguistic characteristics of previous content items the particular user has interacted with in previous content interactions;
determining, by the computing system, an augmentation action based on the linguistic characteristics and the one or more text strings of the content item, wherein the augmentation action comprises augmenting the content item to comprise at least a subset of the linguistic characteristics of the historical user data;
processing, by the computing system, the content item and the augmentation action with a generative language model to generate an alternative content item, wherein the alternative content item comprises an augmented version of the content item that comprises the at least the subset of the linguistic characteristics; and
providing, by the computing system, the graphical user interface for display to the particular user with the content item replaced with the alternative content item.

12. The method of claim 11, further comprising:
determining, by the computing system, the linguistic characteristics are associated with a particular dialect, and wherein the augmentation action comprises augmenting the content item to comprise the terminology and syntactical structure of the particular dialect.

13. The method of claim 12, wherein the particular dialect is a region-specific dialect.

14. The method of claim 11, wherein the content item comprises a multimodal content item, wherein the multimodal content item comprises the one or more text strings and one or more images.

15. The method of claim 14, further comprising:
processing, by the computing system, the historical user data to determine image preferences of the particular user based on previous content items the particular user has interacted with in previous content interactions;
processing, by the computing system, the one or more images and the image preferences with an image augmentation model to generate one or more augmented images based on the image preferences; and
providing, by the computing system, the graphical user interface for display to the particular user with the one or more images replaced with the one or more augmented images.

16. The method of claim 15, wherein the one or more augmented images are generated by augmenting the one or more images to adjust at least one of the brightness, contrast, smoothness, or colors of the one or more images.

17. One or more non-transitory computer-readable media that collectively store instructions that, when executed by one or more computing devices, cause the one or more computing devices to perform operations, the operations comprising:
obtaining a content item for inclusion in a graphical user interface, wherein the content item comprises one or more text strings;
obtaining user profile data associated with a particular user requesting to view the graphical user interface that comprises the content item, wherein the user profile data is descriptive of previous content items viewed by the particular user;
determining one or more topics associated with the one or more text strings of the content item;
processing the one or more topics and the user profile data to determine one or more expertise levels of the particular user, wherein the one or more expertise levels of the particular user are descriptive of a determined level of knowledge of the particular user with the one or more topics;
processing the content item and data descriptive of the one or more expertise levels of the particular user with a generative language model to generate an alternative content item, wherein the alternative content item comprises an augmented version of the content item based on the one or more expertise levels of the particular user; and
providing the graphical user interface for display to the particular user with the content item replaced with the alternative content item.

18. The one or more non-transitory computer-readable media of claim 17, wherein the operations further comprise:
determining to generate an alternative version of the content item based on the one or more expertise levels and the one or more text strings of the content item.

19. The one or more non-transitory computer-readable media of claim 18, wherein the content item comprises a graphical card generated based on a plurality of user inputs by one or more other users; and
wherein determining to generate the alternative version of the content item comprises determining a difference in knowledge expertise of the particular user and the one or more users with respect to the one or more topics.

20. The one or more non-transitory computer-readable media of claim 17, wherein the alternative content item is generated on a user computing device associated with the particular user.
